(19) United States
(12) Patent Application Publication
(10) Pub. No.: US 2011/0126104 A1
(43) Pub. Date: May 26, 2011

(54) USER INTERFACE FOR MANAGING DIFFERENT FORMATS FOR MEDIA FILES AND MEDIA PLAYBACK DEVICES

(75) Inventors: Thomas Steven Woods, Arlington Heights, IL (US); Melvin Grefalda, Chicago, IL (US)

(73) Assignee: Rovi Technologies Corporation, Santa Clara, CA (US)

(21) Appl. No.: 12/623,230

(22) Filed: Nov. 20, 2009

(51) Int. Cl. G06F 3/048; H04N 7/173; H04N 5/765

(52) U.S. Cl. 715/719; 715/835; 725/86; 386/E05.002

(57) ABSTRACT

Described herein is a media manager user interface (UI) application/engine for managing different formats for media files and playback devices in a media system. The media system may include a source device, at least one playback device, and the media manager UI, coupled through a communication system. A source device may store a plurality of media files for various media forms. Each media file and playback device may have a playback format that is specified by values of one or more format parameters. The media manager UI allows users to select media files stored on the source device for downloading onto selected playback devices through the communication system. The media manager UI may automatically determine and store compatibility data indicating format compatibility between different media files and playback devices, the compatibility data being used to automatically convert media files to the formats of the playback devices.

### RELATED APPLICATIONS

The present patent application is related to the following patent applications each assigned to a common assignee:

U.S. patent application Ser. No. [CP0022] entitled, “DATA DELIVERY FOR A CONTENT SYSTEM,” which is hereby incorporated by reference.

U.S. patent application Ser. No. [CP0023] entitled, “CONTENT INTEGRATION FOR A CONTENT SYSTEM,” which is hereby incorporated by reference.

U.S. patent application Ser. No. [CP0043] entitled, “CONTENT RECOMMENDATION FOR A CONTENT SYSTEM,” which is hereby incorporated by reference.

U.S. patent application Ser. No. [CP0044] entitled, “CONTENT INGESTION FOR A CONTENT SYSTEM,” which is hereby incorporated by reference.

U.S. patent application Ser. No. [CP0036] entitled “MANAGING DIFFERENT FORMATS FOR MEDIA FILES AND MEDIA PLAYBACK DEVICES,” which is hereby incorporated by reference.

### FIELD

The present invention relates to media systems, and, more specifically, to managing different formats for media files and media playback devices in a media system.

### BACKGROUND

The widespread use of computers, digital media devices, e.g., video, audio, image, picture, and/or gaming media devices, and the Internet has resulted in the generation and use of digital media files. Digital media files may contain binary data that provide various forms of media content (e.g., video, audio, image, or gaming content). Media files are typically stored on a computer storage medium that is accessible by computer devices, such as CD-ROMs, hard drives, memory sticks, etc.

The storage of digital media files on computer mediums allows for easy generation and transfer of digital media files. For example, it has become popular to purchase media files (e.g., video and audio files) on the Internet, and download and store the media files to computers. Also, it has become popular to generate digital photos by using a digital camera and then to transfer and store the digital photos to computers. Computer applications permit the user to manipulate and play back the media files. These types of applications have also contributed to the widespread popularity of digital media files.

The media files may then be played (decoded and presented) on a compatible playback device. A playback device may decode the digital media file to convert the digital data to analog signals (digital-to-analog conversion) and present the analog signals by using presentation components. For example, a video or gaming media file may be decoded and presented on a playback device having video and audio components (e.g., a display and speakers or headphones), an audio media file may be decoded and presented on a playback device having audio components (e.g., speakers or headphones), and an image media file may be decoded and presented on a playback device having video components (e.g., display).

### SUMMARY

Although digital media files may be easily transferred/distributed and stored to computers, the growing number of different media formats for each media form have made playback of the media files more complicated. In general, different media formats have emerged for each form of media content (e.g., video, audio, image, or gaming content), whereby a playback device is typically capable of playing back some media formats and not capable of playing others. A particular playback format of a media file may by defined or specified by a set of one or more media file format parameter values, such as encoding type (e.g., MP3, MPEG-4, etc.), display aspect ratio (width to length ratio), display resolution, and the like. This is because specialized hardware and/or software is required to playback a particular media format, and a playback device typically does not contain all hardware and/or software capable of playing back all available media formats.

The playback of digital media files is less problematic on a computer because the computer may play the digital media files by using several software applications that may decode several different formats. A computer may also use a format conversion application such as a transcoder to convert and store digital media files to a format that it is capable of playing. However, a playback device typically has a smaller storage space and is not capable of storing and executing different software applications for decoding different formats or for converting and storing digital media files in different formats. Accordingly, it is desirable to provide a way to manage different formats of media files so they may be playable in different playback devices.

Described herein is a media manager user interface (UI) application/engine for managing different formats for media files and playback devices in a media system. The media system may include at least one source device, at least one playback device, and a manager device executing the media manager UI, coupled through a communication system. A source device may store a plurality of media files for various media forms, e.g., video, audio, image, or gaming media files. Each media file may have a particular playback format that is defined or specified by values of one or more media file format parameters, e.g., encoding type, display aspect ratio, etc.

A playback device may comprise a storage device, for storing downloaded media files, and components for playing back, decoding, and/or presenting the media files. For example, a playback device may comprise a decoding application, engine, and/or decoder and presentation components, e.g., video and/or audio components, for presenting media content, e.g., video and/or audio content, stored on the media files. A playback device may be configured to playback media files in an “optimal format” comprising an “optimal set of format parameter values” for the playback device. The optimized set of format parameter values may comprise required and/or preferred format parameter values.

The manager device may comprise components, including hardware and/or software, configured for converting and managing media files stored on the source device. The manager device may also include a user interface application and/or engine, referred to as a media manager UI, for managing the formats of the media files and playback devices, in accordance with embodiments described herein. The media manager UI may be advantageously used to provide media files in optimized formats for each registered playback device, for instance, based on format parameter values registered for the playback device. In some embodiments, the media manager UI may provide media files in an optimized format for each registered playback device automatically without requiring particular user interactions.

In some embodiments, the media manager UI produces and maintains a data structure (“media data structure”) storing data describing media files and/or media devices. Each media file may be represented by a media file entry in the media data structure, the media file entry containing multiple fields for storing data describing the media file. Also, one or more playback devices may be registered with the media manager UI through a registration process. Each registered playback device may also be represented by a playback device entry in the media data structure, the playback device entry containing multiple fields for storing data describing the playback device.

The media manager UI may allow users to select media files stored on the source device for downloading onto selected playback devices for example, through the communication system. As discussed above, a playback device may have an optimized format comprising an optimized set of required and/or preferred format parameter values. Also, a playback format of a media file may by defined or specified by at least one format parameter value, such as for encoding type, display aspect ratio, display resolution, etc. In some embodiments, prior to downloading a selected media file onto a selected playback devices, the media manager UI uses the media data structure to determine a format conversion, if any, needed for a selected media file to have format parameters that match the optimized set of format parameter values of the selected playback device.

The media manager UI may do so by determining, by using the media data structure, whether one or more differing format parameter values of a selected playback device do not match with a selected media file. If so, the selected media file is converted to have the same format parameter values as the optimized format parameter values of the selected playback device. The media manager UI may do so by sending the differing format parameter values to the transcoder, which then converts the selected media file to produce a converted media file having the optimized format parameter values of the selected playback device.

To illustrate, a selected media file may be in a first format defined by the set of format parameter values, which are preferably recorded in the media data structure: encoding type A, display aspect ratio B, and display resolution C. Further, a selected playback device may preferably playback media files in a second format defined by format parameter values, which are preferably recorded in the media data structure: encoding type X, display aspect ratio Y, display resolution C. The media manager UI may then determine, by examining the media data structure, that the format parameter values for the encoding type and display aspect ratio of the selected playback device is not matched by the corresponding format parameter values for the encoding type and display aspect ratio of the selected media file. As such, the differing format parameters values are encoding type X and display aspect ratio Y, e.g., the format parameter values of the selected playback device that are not matched by the corresponding format parameter values of the selected media file. The media manager UI then sends the format parameter values of encoding type X and display aspect ratio Y to the transcoder which then converts the selected media file to produce a converted media file having the received format parameter values. The converted media file will therefore have the same format parameter values as the selected playback device and playback will be optimized on the device.

### BRIEF DESCRIPTION OF THE DRAWINGS

The novel features are set forth in the appended claims. However, for purpose of explanation, several embodiments of the invention are set forth in the following figures.

FIG. 1 is a block diagram of an exemplary media system environment in which some embodiments operate;

FIG. 2 is a diagram illustrating various components of a manager device, in accordance with some embodiments;

FIG. 3A is a flowchart of a method for producing data for media files for storing in the media data structure;

FIG. 3B is a flowchart of a method for producing data for playback devices for storing in the media data structure;

FIG. 4A is a diagram conceptually illustrating steps of the method of FIG. 3A;

FIG. 4B is a diagram conceptually illustrating steps of the method of FIG. 3B;

FIG. 5 shows an exemplary media data structure;

FIG. 6 is a flowchart of a method for using the media data structure for converting media files to optimal formats of playback devices;

FIG. 7 is a diagram conceptually illustrating steps of the method of FIG. 6;

FIG. 8 shows an exemplary media data structure containing data for related converted media files;

FIG. 9 is a flowchart of a method for allowing users to select media files for downloading onto playback devices and managing playback formats of the media files and playback devices; and

FIG. 10 shows an exemplary screen shot of the media manager UI showing a menu interface for selecting different media UI applications;

FIG. 11 shows an exemplary screen shot of a video UI application displaying video media items;

FIG. 12 shows an exemplary screen shot of a video UI application displaying video media files;

FIG. 13 shows an exemplary screen shot of a video UI application for purchasing and downloading media files from a content provider;

FIG. 14 shows an exemplary screen shot of a video UI application displaying “never compatible” playback devices;

FIG. 15 shows an exemplary screen shot of a video UI application displaying a download queue for a playback device; and

FIG. 16 shows an exemplary screen shot of a video UI application displaying a “Synch” icon for beginning download of selected media files.

### DESCRIPTION

In the following description, numerous details are set forth for purpose of explanation. However, one of ordinary skill in the art will realize that the embodiments described herein may be practiced without the use of these specific details. In other instances, well-known structures and devices are shown in block diagram form in order to not obscure the description with unnecessary detail.

The description that follows is divided into three sections. Section I describes a media system environment in which some embodiments operate. Section II describes a manager device for managing media files and playback devices in the media system. Section III describes a media manager user interface for managing the media files and playback devices in the media system.

### I. Media System Environment

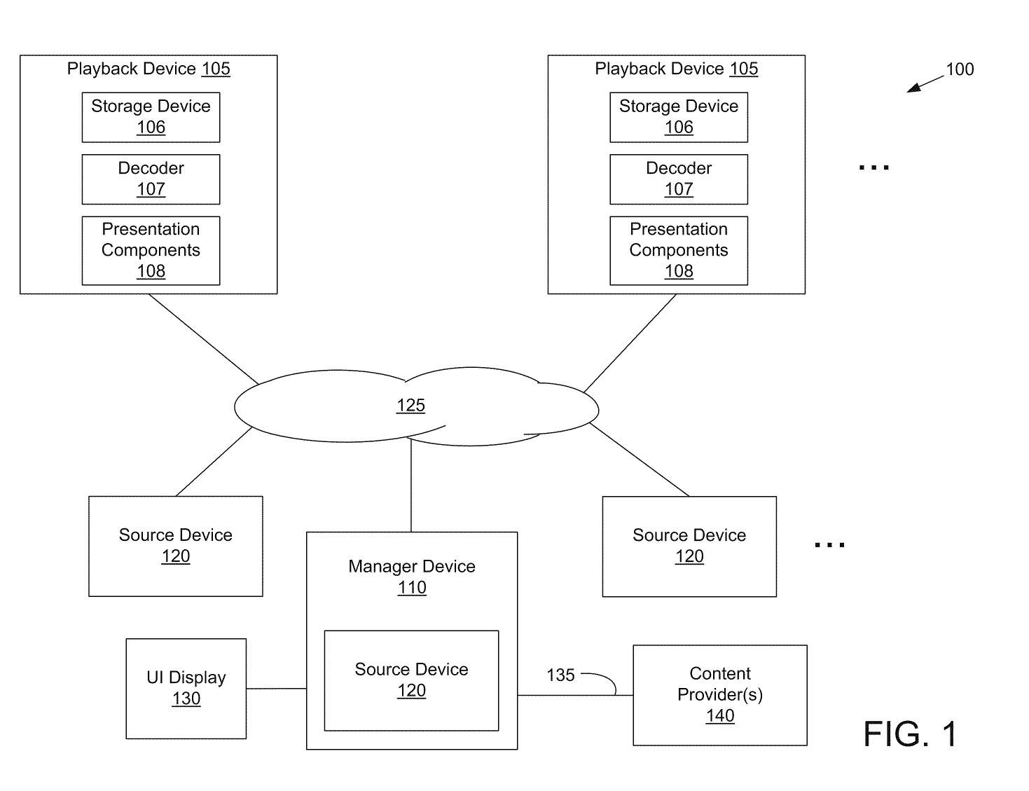

FIG. 1 is a block diagram of an exemplary media system environment 100 in which some embodiments operate. As shown in the FIG. 1, the environment 100 comprises one or more source devices 120, one or more playback devices 105, and a manager device 110 coupled through a communication system 125.

A source device 120 may store a plurality of digital media files for various media forms. In some embodiments, a source device 120 may store a plurality of video, audio, image, and/or gaming media files. In other embodiments, a source device 120 may store media files of other media forms. Each media file may have a particular playback format that is defined or specified by values of one or more media file format parameters (e.g., encoding type, display aspect ratio, etc.). A source device 120 may store a plurality of “original” media files as well as “converted” media files that were produced by converting the playback format of “original” media files.

A source device 120 may comprise hardware and/or software components configured for storing media files. The source device 120 may comprise one or more writable media storage devices, such as disk drives, video tape, magnetic tape, optical devices, CD, DVD, Blu-ray, flash memory, Magnetic Random Access Memory (MRAM), Phase Change RAM (PRAM), a solid state storage device, or another similar device adapted to store data. A source device 120 may implement a file system to provide directories containing filenames for media files. In some embodiments, the source device 120 and the manager device 110 may comprise a single device, e.g., computer server, that is coupled to the communication system 125. In other embodiments, a source device 120 and the manager device 110 may comprise separate devices each coupled to the communication system 125. In these embodiments, the source device 120 may comprise a dedicated stand-alone storage device, such as a network-attached storage (NAS) or Storage Area Network (SAN) device.

The playback device 105 may comprise a storage device 106 such as for storing downloaded media files, and components 107 and 108 for playing back, decoding and/or presenting the media files. The storage device 106 may comprise a device similar to the source device 120 and similarly configured for storing digital media files for example, a disk drive, flash memory, etc., but typically comprises a significantly smaller amount of storage space than the source device 120. The playback device 105 also may comprise a decoder 107 for decoding the encoded digital media files. The decoder 107 may be configured for converting the encoded digital data of the media files to analog signals, e.g., digital-to-analog conversion, and pass the analog signals to presentation components 108. In particular, the decoder 107 may be configured for converting a particular encoding type for a media file. As such, each encoding type of a media file may require a particular type of decoder 107 as well. The presentation components 108 including for example, video and/or audio components, may be configured for receiving and presenting the analog signals representing the media content, e.g., video and/or audio content, stored on the media files. For example, the presentation components 180 may include a display such as a television, speakers, headphones, and/or output components for outputting video and/or audio to the display or to the speakers or headphones. A variety of displays and/or televisions are contemplated including, for example, a liquid crystal display “LCD”, a light emitting diode (LED), a cathode ray tube (CRT), and/or a plasma type television, monitor and/or display.

In some embodiments, the playback device 105 may comprise a portable mobile device whereby the storage, decoding, and presentation components are integrated within a single portable device. Examples of portable mobile playback devices include cell phones, smartphones, BlackBerrys, personal digital assistants (PDAs), convergent devices, portable video players, portable music players, e.g., MP3 players, portable video game players, car media players, playback devices installed in cars, etc. In other embodiments, a portable device comprises other such devices. Note that typically, if the playback device 105 is a portable audio device, the presentation component 108 of the playback device 105 may comprise only an audio output component that outputs analog audio to a set of external headphones.

In other embodiments, the playback device 105 may comprise a non-portable device whereby the storage, decoding, and/or presentation components are contained within two or more separate devices, that collectively comprise the playback device 105. For example, a first device may contain the storage and decoding components 106 and 107, the first device being coupled with a second device that includes the presentation components 108, the first and second devices collectively comprising the playback device 105. Examples of the first device include a digital video recorder (DVR), a CD or DVD player with a hard drive, etc. Examples of the second device include a television such as for presenting videos, images, and games, a stereo receiver and/or amplifier for presenting audio, etc. In other embodiments, the first and second devices comprise other such devices.

Although a playback device 105 may be configured to playback media files in different formats, a particular format, and particular format parameter values, may be optimized for the playback device, e.g., depending on the type of decoder and/or presentation components. In general, a playback device 105 may require that a media file have a certain format parameter value to be playable. For example, to be able to decode a media file, the decoder 107 may require that the media file have a particular encoding type, such as MP3.

However, other format parameter values of a media file may only be preferred, and not required, for a playback device, e.g., for better playback performance, for minimizing storage space, etc. For example, some format parameter values such as display aspect ratio and/or display resolution, may relate to presentation components that are preferred for the playback device, but not required for playback. The display aspect ratio may be a preferred or required format parameter depending on the playback device. For example, some playback devices may be configured to automatically adjust the display aspect ratio (within limitations) of the media file for displaying on the display of the playback device. Other playback devices, however, may not have such capabilities and require that the display aspect ratio be a particular value.

As a further example, the display resolution may be a preferred format parameter value. For example, a media file with a relatively lower display resolution, and thus requiring less storage space, may still provide sufficient playback quality on a playback device with relatively smaller displays. As such, during a registration process for the playback device, the preferred display resolution may be set to a relatively low display resolution Z, which provides sufficient playback quality while also having a small storage size.

The set of format parameter values that include the “required” and “preferred” format parameter values of a playback device may sometimes be referred to as an “optimized format” or an “optimized set of format parameter values” of the playback device. As such, the optimized format of a playback device may specify zero or more required format parameter values and zero or more preferred format parameter values. For a media file having the optimized format of a playback device, the media file and playback device may be referred to herein as being “compatible” with one another. Also, a media file that is “incompatible” with the optimal format of a playback device may be converted to produce a media file that is compatible with the optimal format.

The manager device 110 may comprise components, including hardware and/or software, that are configured for converting and managing media files stored on the source device(s) 120 for use on the playback device(s) 105. Due to the plurality of different formats for media files and playback devices and the relatively small storage space provided in a playback device, the manager device 110 may be advantageously used to provide media files in optimized formats for each registered playback device for example, based on format parameter values registered for the playback device. In some embodiments, the manager device 110 may provide media files in an optimized format for each registered playback device automatically without requiring particular user interactions, e.g., without requiring a user to select format parameter values for a media file and submit a request to convert the media file according to the selected format parameter values, etc. As such, the manager device 110 operations for providing media files in an optimized format for each registered playback device may be performed transparent to the user, without requiring user or human initiation, interaction, or intervention.

The manager device 110 may include a file format conversion application and/or engine (transcoder) to convert digital media files to different formats based on received format parameter values. The manager device 110 may also include a user interface application and/or engine (“media manager UI”) for interacting with the manager device 110 to manage the formats of the media files and playback devices, in accordance with embodiments described herein. The media manager UI may be displayed on a UI display 130 coupled with the manager device 100. For example, the UI display 130 may comprise a computer monitor or television, so the user may watch television while also interacting with the media manager UI.

The source device(s) 120, playback device(s) 105, and the manager device 110 may be coupled through a communication system 125. The communication system 125 may comprise a wired, direct connect, and/or wireless system. The communication system 125 may be implemented by using, for example, a wired or wireless network, a personal area network (PAN), a local area network (LAN), a wide area network (WAN), a virtual private network (VPN) implemented over a public network such as the Internet, etc., and/or by using radio frequency (RF), infrared (IR), Bluetooth, etc. In other embodiments, the communication system 125 may be implemented by using other means. For example, the communication system 125 may comprise a network implemented in accordance with standards, such as Ethernet 10/100/1000 over Category 5 or 6, HPNA, Home Plug, IEEE 802.x, IEEE 1394, USB 1.1, 2.0, etc.

Some embodiments described herein may be implemented through use of the communication system 125. In particular, embodiments requiring communications and/or interactions between components of the media system 100 including, for example, source device(s) 120, playback device(s) 105, and the manager device 110, may be implemented through the communication system 125. For example, media files of a source device 120 may be processed by the manager device 110 and a playback device may be analyzed by the manager device 110 through use of the communication system 125. As a further example, a playback device 105 may be registered with the manager device 110 and receive user selected media files that are downloaded and stored to the playback device 105 through the communication system 125. For example, a playback device 105 may comprise a car media player such as a video player installed in a car that is coupled to the manager device 110 and the source device(s) 120 through a coupling, e.g., over Bluetooth. The car media player may be registered, generally upon a first interaction, with the manager device 110 through the Bluetooth coupling and then receive user selected media files that are downloaded and stored to the car media player through the communication system 125.

In some embodiments, the media system 100 comprises a home and/or local media system and the communication system 125 comprises a home and/or local communication system including, for example, a home and/or local network. The manager device 100 may also be coupled to content providers 140 that are located external to the home and/or local media system and the home and/or local communication system. The manager device 100 may access such content providers 140, for example, for purchasing and/or downloading content comprising externally located media files, which may then be stored to a source device 120. The manager device 100 may be coupled to the content providers 140 through an external network 135 for example, the Internet, private distribution networks, etc. In other embodiments, the external content may be transmitted and/or broadcasted. For example, the manager device 100 may access external content through a data casting service including, for instance, data modulated and transmitted by using RF, microwave, satellite, or another transmission technology.

### II. Manager Device

### A. Components of Manager Device

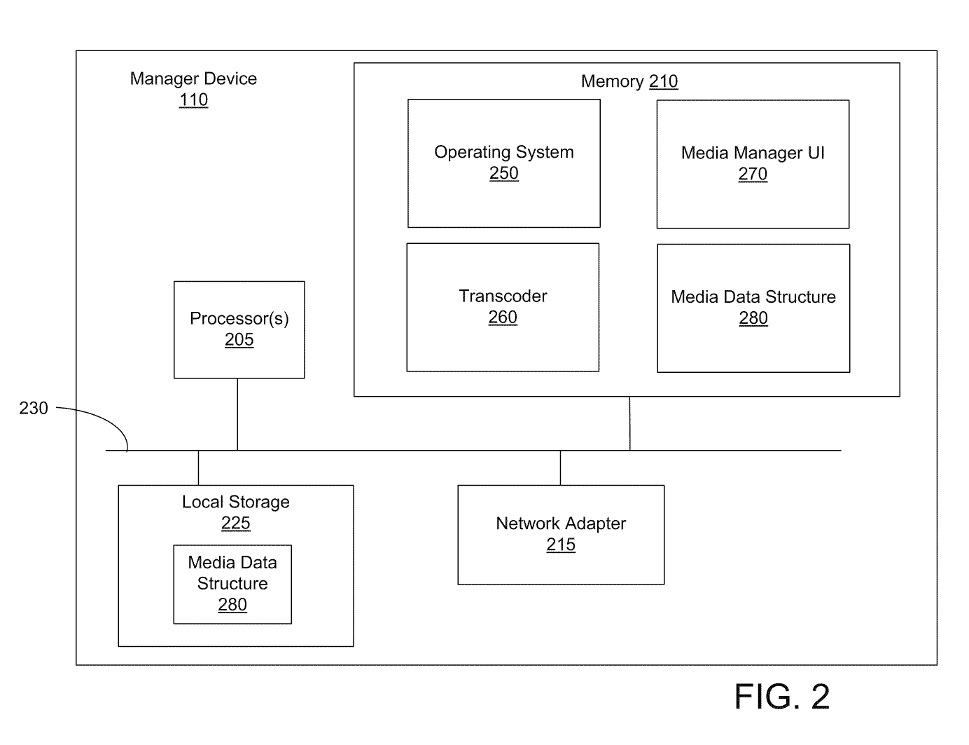

FIG. 2 is a diagram illustrating various components of a manager device 110, in accordance with some embodiments. The manager device 110 comprises processor(s) 205, memory 210, a communications system adapter 215, and a local storage 225 coupled by a bus 230.

The processors 205 are the central processing units (CPUs) of the manager device 110. The processors 205 may include programmable general-purpose or special-purpose microprocessors, digital signal processors (DSPs), programmable controllers, application specific integrated circuits (ASICs), programmable logic devices (PLDs), or the like, or a combination of such devices. A communications system adapter 215 may comprise mechanical, electrical and signaling circuitry needed to couple the manager device 110 to the communication system 125 and to receive and transmit data over the communication system 125. For example, the communications system adapter 215 may comprise a network port controller, e.g., Ethernet cards, for receiving and transmitting data over a network 125. A communications system adapter 215 may be used to couple the manager device 110 to a source device 120 and/or a playback device 105 through the communication system 125.

The local storage 225 may comprise a non-volatile storage device that stores information within the manager device 110. The manager device 110 loads information stored on the local storage 225 into a memory 210 from which the information is accessed by the processors 205. In some embodiments, the media data structure 280 is stored on a local storage 225 that is non-volatile. In some embodiments, the local storage 225 may also store media files and therefore comprise or function as a source device 120.

The memory 210 comprises storage locations that are addressable by the processor 205 for storing software program code. The processor 205 and adapters may, in turn, comprise processing elements and/or logic circuitry configured to execute the software code. For example, the memory 210 may be a random access memory (RAM), a read-only memory (ROM), or the like. In some embodiments, the memory 210 stores instructions and/or data for an operating system 250, a transcoder 260, a media manager UI 270, and a media data structure 280.

The transcoder 260 may comprise a file format conversion application and/or engine to convert digital media files to different formats based on received format parameter values. For example, the transcoder 260 may receive a media file with encoding type A, and receive a format parameter value of encoding type B, and thus convert the media file to produce a new media file with encoding type B, whereby all other format parameter values may remain unchanged. As another example, a transcoder 260 may receive a media file with encoding type A and aspect ratio X, and receive a format parameter value of encoding type B and aspect ratio Y, and thus convert the media file to produce a new converted media file with encoding type B and aspect ratio Y, whereby all other format parameter values may preferably remain unchanged).

The media manager UI 270 may comprise a user interface application and/or engine for interacting with the manager device 110 to manage the formats of the media files and playback devices, in accordance with embodiments described herein. The media manager UI 270 may do so by automatically producing the media data structure 280 for storing format data for media files and registered playback devices and for using the media data structure 280 for automatically converting media files to optimized formats of the registered playback devices. The media manager UI 270 may produce a plurality of user interactive screens shown on a display 130, such as a computer monitor or a television that is coupled with the manager device 110.

### B. Producing Media File Data of the Media Data Structure

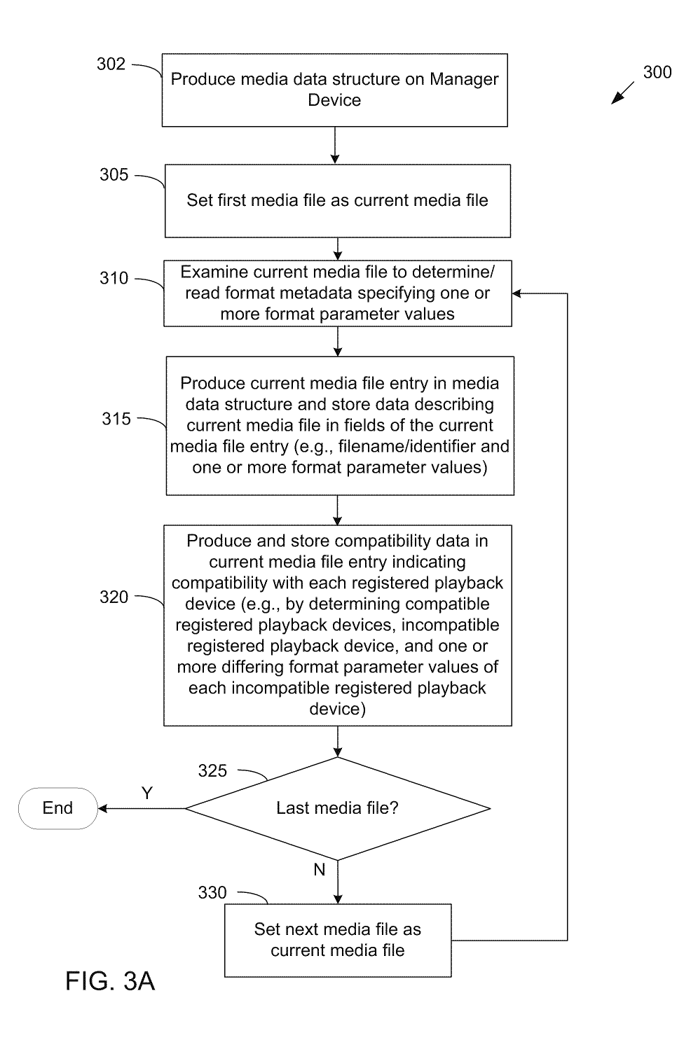

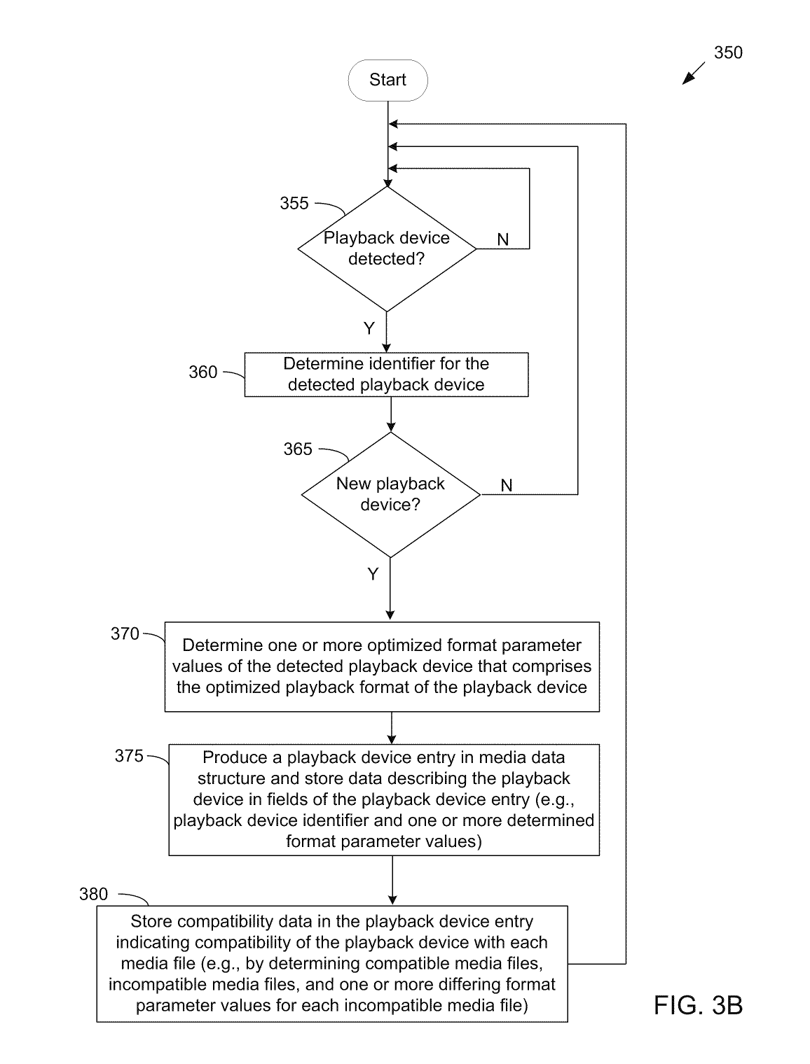

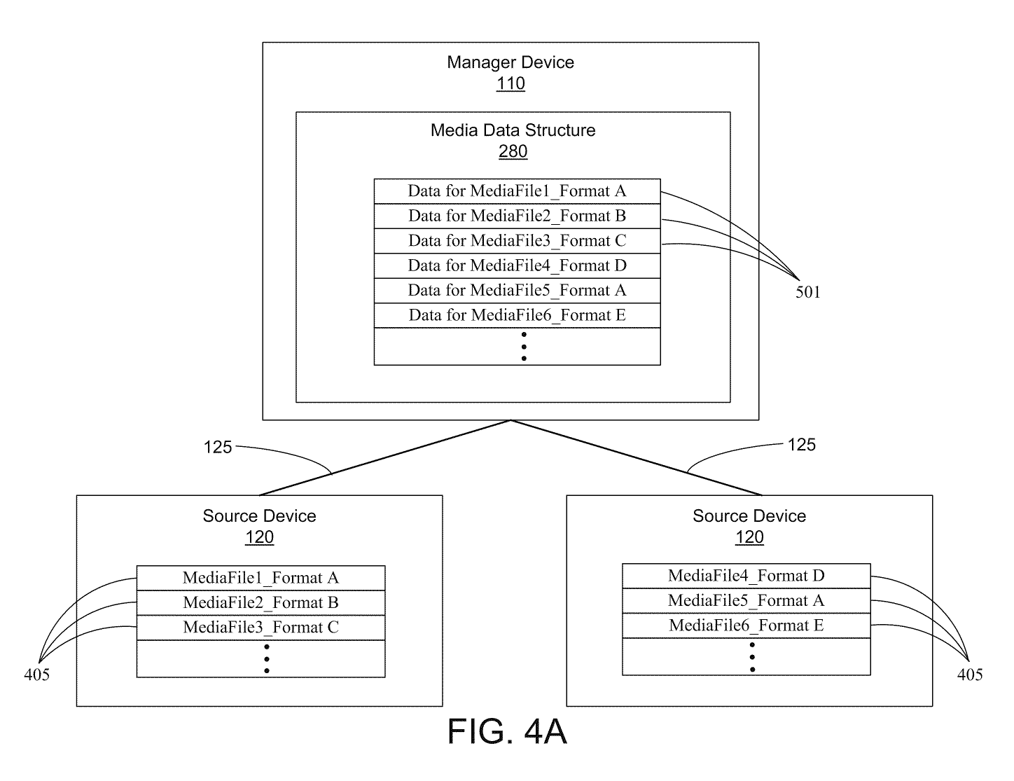

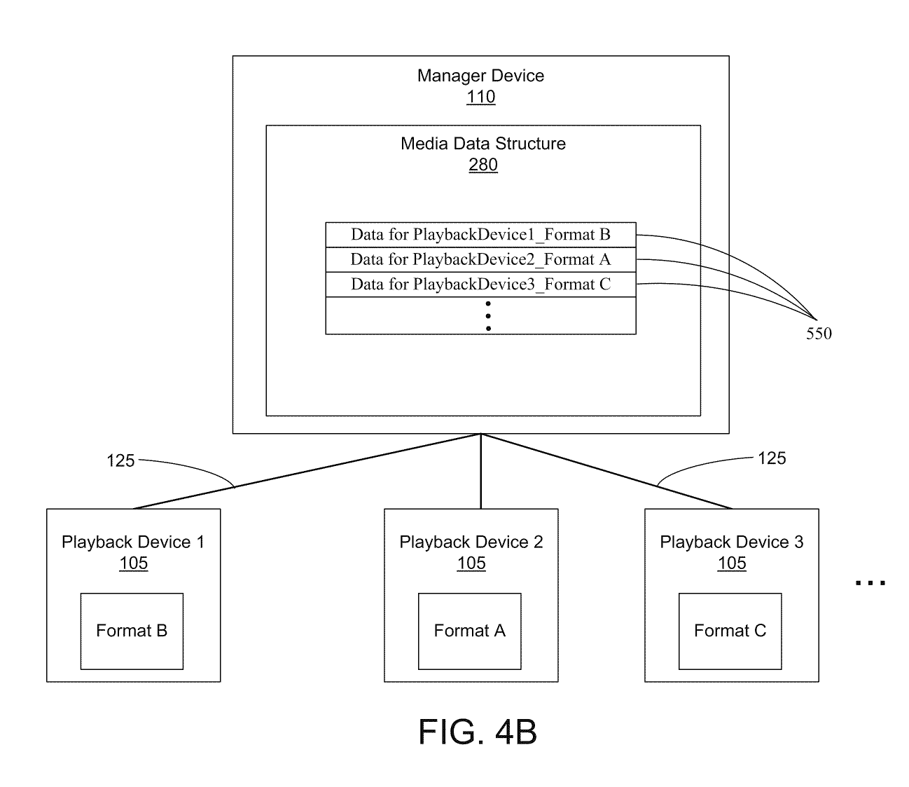

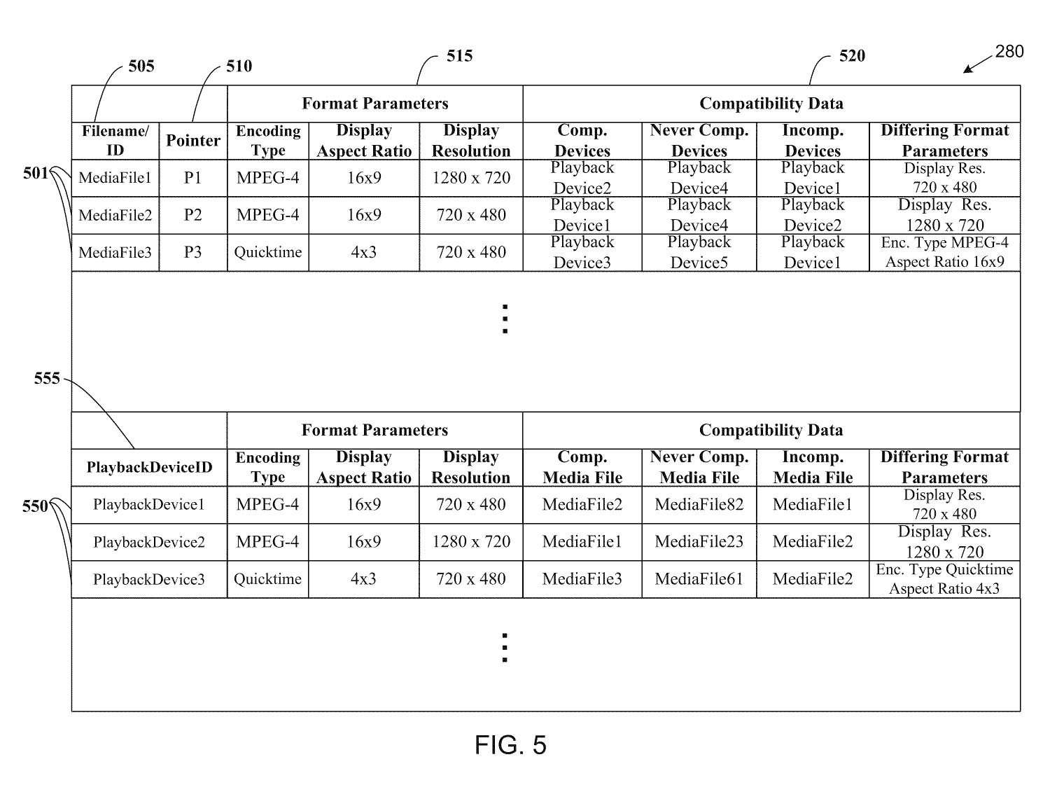

FIGS. 3A-B are flowcharts that illustrate methods of producing media data for storing in the media data structure 280. FIG. 3A is a flowchart illustrating a method 300 of producing data for media files for storing in the media data structure 280. The method 300 of FIG. 3A is described in relation to FIG. 4A which conceptually illustrates steps of the method 300 and FIG. 5 which shows an exemplary media data structure 280. FIG. 3B is a flowchart illustrating a method 350 of producing data for playback devices for storing in the media data structure 280. The method 350 of FIG. 3B is described in relation to FIG. 4B which conceptually illustrates steps of the method 350 and FIG. 5. In some embodiments, the methods 300 and 350 may be performed independently and simultaneously to produce data for media files and playback devices for storing in the media data structure 280. In some embodiments, some of the steps of the methods 300 and 350 may be performed automatically, without requiring user or human initiation, interaction, or intervention. In some embodiments, some of the steps of the methods 300 and 350 may be performed by the media manager UI 270. The order and number of steps of the methods 300 and 350 are for illustrative purposes only and, in other embodiments, a different order and/or number of steps are used.

As shown in FIG. 3A, the method 300 begins by producing (at a step 302) the media data structure 280 on the manager device 110, e.g., as stored in memory 210 and/or in local storage 225. The method 300 then sets (at a step 305) a first media file in the media system 100 as a current media file for processing. The media file may be stored in a source device 120 of the media system 100. The method examines (at a step 310) the current media file to determine and/or read “format metadata” that describes the current media file. Preferably, the format metadata specifies one or more format parameter values, e.g., encoding type, display aspect ratio, etc., of the current media file. For example, the format metadata may be extracted and read from a header section of the current media file. In other embodiments, other methods are used to read format metadata of the current media file. The method then produces (at a step 315) an entry (“current media file entry”) in the media data structure 280. The media file entry contains multiple fields, and stores data describing the current media file in the fields of the current media file entry. For example, the method 300 may store the media filename, an identifier for the current media file, and/or one or more determined format parameter values in the current media file entry.

The method then produces and stores (at a step 320) compatibility data in the current media file entry indicating compatibility of the current media file with each registered playback device. The compatibility data for the current media file may be determined by examining data describing each registered playback device which is also stored in the media data structure 280, as described below. For example, the data for a particular playback device may comprise format parameter values specifying an optimized playback format of the particular playback device. The method 300 may produce the compatibility data (at the step 320) by examining the format parameter values of the particular playback device and the current media file to determine whether format parameter values of the playback device, referred to as “differing format parameter values”, is not matched by the corresponding format parameter values of the current media file. Also at the step 320, the method 300 stores the differing format parameter values in the media file entry. In other embodiments, the method 300 may store other data describing the current media file in the current media file entry. The method then determines (at a step 325) whether the current media file is the last media file in the media system 100. If so, the method 300 concludes, after the step 325. If not, the method sets (at a step 330) a next media file in the media system 100 as a current media file and returns to the step 310 for processing the current media file.

In some embodiments, for each media file, the method 300 automatically examines the media file (at the step 310), to determine format parameter values of the media file, and stores format parameter values and compatibility data (at the steps 315 and 320) for the media file in the media data structure 280. The method may do so without first requiring a user to request the media files to be examined and without first requiring a user to request the format parameter values and/or compatibility data for the media file be stored in the media data structure 280.

FIG. 4A conceptually illustrates steps of the method 300 of FIG. 3A. As shown in the example of FIG. 4A, a source device 120 may store a plurality of media files 405. Each media file 405 may have a particular playback format, e.g., Format A, B, or C, defined or specified by a set of one or more format parameter values. As shown in the example of FIG. 4A, data for each media file 405 is stored in a media file entry 501 produced for the media file 405 in the media data structure 280.

FIG. 5 shows an exemplary media data structure 280. As shown in FIG. 5, the media data structure 280 comprises a plurality of media file entries 510. Each media file entry 501 represents a media file 405 and stores data describing the media file 405 in a plurality of data fields. For example, a media file entry 501 may contain fields for a media file identifier 505, e.g., a filename, a pointer 510 to a storage location where the media file is stored, e.g., a storage address on the source device, and format parameter values 515. The format parameters 515 may include encoding type, display aspect ratio, display resolution, and similar parameters.

Examples of values for encoding types for audio media files include Moving Pictures Experts Group Layer 3 (MP3), Microsoft Windows Media Audio (WMA), Pulse Code Modulated (PCM), Real Audio, Advanced Audio Coding (AAC), 3rd Generation Partnership Project (3GPP), Audio Interchange File Format (AIFF), Free Lossless Audio Codec (FLAC), Apple Lossless, etc. Examples of values for encoding types for video media files include Moving Pictures Experts Group Layer 1, 2, or 4 (MPEG-1, MPEG-2, or MPEG-4), Moving Joint Photographic Experts Group (MJPEG), Quicktime, Microsoft Windows Media Video (WMV), Real Video, Flash Video, Audio Video Interleaved (AVI), H.264 Coding, Advanced Video Coding (AVC), etc. Examples of values for encoding types for image media files include Joint Photographic Experts Group (JPEG), Graphics Interchange Format (GIF), Portable Network Graphics (PNG), BitMaP (BMP), etc. In other embodiments, any other type of encoding may be used.

For video or gaming media files, format parameters may include display aspect ratio and/or display resolution. Examples of values for display aspect ratio include 4×3 for standard displays, 16×9 for widescreen displays, 1×1 and narrower for mobile device displays, etc. In other embodiments, any other display aspect ratio may be used. Examples of values for display resolution include 720×480, 720×576, 1280×720, 1280×1080, 1440×1080, 1920×1080, etc. In other embodiments, another display resolution may be used.

As shown in the example of FIG. 5, a media file entry 501 may also contain fields for compatibility data 520. For example, a media file entry 501 may include fields for listing identifiers for zero or more compatible playback devices, zero or more “never compatible” playback devices, and zero or more incompatible playback devices. As discussed above, a playback device may have an optimized format comprising an optimized set of required and/or preferred format parameter values. A playback device may be listed as compatible with a media file when each specified format parameter value for the playback device matches each specified format parameter value for the media file.

A playback device may be listed as never compatible with a media file when the media file can not be made compatible with the playback device by any conversion of the media file. This may occur when the transcoder 260 is not be capable of converting at least one format parameter value of the media file to match the corresponding format parameter value of the playback device. The media manager UI may determine which playback devices are never compatible by examining capabilities of its transcoder 260, which may specify its format conversion capabilities. As such, which playback device is determined to a “never compatible” playback device may depend on the conversion capabilities of the transcoder 260. The transcoder 260 may be updated, e.g., through firmware and/or software updates, and may obtain new conversion capabilities, whereby the media manager UI may adjust the compatibility data 520 according to the new or updated transcoder conversion capabilities.

In contrast, an incompatible playback device may be incompatible with the media file, but the media file may be made compatible by conversion of one or more format parameters of the media file. For each incompatible playback device, for a media file entry 501 representing a particular media file, the compatibility data 520 may further include optimized format parameter values (“differing format parameter values”) of the incompatible playback device that do not match the corresponding format parameter values of the particular media file. Note that the “differing format parameter values” comprise an optimized format parameter values of the playback device that are not matching, rather than the format parameter values of the media file. This is because the particular media file and the differing format parameter values may be later sent to the transcoder 260 which converts the particular media file based on the differing format parameter values, and thus producing a new converted media file having optimized format parameter values for the playback device. As such, the compatibility data 520 and the differing format parameter values may specify the media file conversions needed to make the media file compatible with a particular playback device.

### C. Producing Playback Device Data of the Media Data Structure

FIG. 3B is a flowchart that illustrates a method 350 of producing data for playback devices for storing in the media data structure 280. As shown in FIG. 3B, the method 350 begins by determining (at a step 355) whether a playback device has been detected on the communication system 125. The method 350 may do so by determining whether a playback device has been coupled to the manager device 110 through the communication system 125 by using a device discovery method. For example, the media system 100 may support an industry defined discovery protocol for example, Universal Plug and Play (UPnP) protocol, Service Location Protocol (SLP), etc., for automated discovery of devices over networks. If a playback device is not coupled, the method 350 continues at step 355. If a playback device is coupled, the method 350 continues at step 360.

The method 350 determines (at the step 360) an identifier for the detected playback device. For example, typically each hardware device (such as playback devices, network adapters, network interface cards, etc.) that connects to a network has a unique Media Access Control address (MAC address). The MAC address may comprise a unique identifier assigned to the hardware device by the manufacturer for identification, and used in the Media Access Control protocol software layer. If assigned by the manufacturer, a MAC address may encode the manufacturer's registered identification number. The MAC address may also be known as an Ethernet Hardware Address (EHA), hardware address, adapter address, or physical address. In some embodiments, the method 350 may produce and determine an identifier for the detected playback device based on the MAC address of the playback device.

The method 350 then determines (at a step 365) whether the detected playback device is a new playback device requiring registration. The method 350 may do so by determining if the determined playback device identifier does not match any playback device identifier for a playback device entry in the media data structure 280. If so, the detected playback device is a new playback device requiring registration and the method continues at step 370. If not, the detected playback device is a previously registered playback device and the method continues at the step 355.

The method 350 then determines (at the step 370) one or more optimized format parameter values, e.g., encoding type, display aspect ratio, etc., for the playback device that comprises an optimized playback format for the playback device. For example, the method 350 may do so by determining the brand and model number of the playback device and retrieving specifications of the playback device from the Internet through an external network 135. The retrieved specifications may include optimized format parameter values, e.g., encoding type, display aspect ratio, etc., or other information that may be used to determine optimized format parameter values. For example, the specifications may include the display size of the playback device, wherein an optimized display resolution for the playback device may be automatically set to a default value based on the display size. For example, a display size of 15-inches may have a default display resolution of 1024×768, a display size of 17-19 inches may have a default display resolution of 1024×1024, etc.

For example, a relatively lower display resolution of a media file, requiring less storage space, may still provide sufficient playback quality on a playback device with relatively smaller displays. As such, the optimized display resolution may be set to a default low display resolution Z, which provides sufficient playback quality while also having a small storage size.

The method 350 may also determine (at the step 370) optimized format parameter values of the playback device by receiving the format parameter values from a user, such as through the media manager UI 270, if the user wishes to manually set particular format parameter values or override format parameter values that were automatically set. For example, if the playback device 105 comprises two separate devices such as a DVR coupled with a television, the user may wish to manually set the format parameter values of the television that is usually coupled with the DVR. In other embodiments, other methods are used to determine optimized format parameter values of the playback device.

The method 350 then produces (at a step 375) an entry (“playback device entry”) in the media data structure 280. The playback device entry contains multiple fields, and stores data describing the playback device in the fields of the playback device entry. For example, the method 350 may store the playback device identifier and one or more determined format parameter values in the playback device entry.

The method 350 then produces and stores (at a step 380) compatibility data 520 in the playback device entry indicating compatibility of the playback device with each media file in the media system 100. The compatibility data for the playback device may be determined by examining data for the media files which is also stored in the media data structure 280, as described above. For example, the method 350 may produce the compatibility data by examining the format parameter values of the playback device and each media file to determine whether there are differing format parameter values with the playback device. The method 350 may store the differing format parameter values in the playback device entry. In other embodiments, the method 350 may store other data describing the playback device in the playback device entry. The method 350 then continues at the step 355.

In some embodiments, either the method 300 of FIG. 3A produces and stores compatibility data for the media files or the method 350 of FIG. 3B produces and stores compatibility data for the playback devices in the media data structure 280, but not both methods, since storing such compatibility data for both may be redundant. The method then continues at the step 355. In some embodiments, for each playback device, the method 350 automatically registers (at the steps 370 and 380) a new playback device without first requiring a user to request that the new playback device be registered.

FIG. 4B conceptually illustrates steps of the method 350. As shown in the example of FIG. 4B, a plurality of playback devices 105 may be coupled through the communication system 125 to the manager device 110. Upon the initial connection to the manager device 110, each playback device 105 is registered with the manager device 110 by using the method 350 of FIG. 3B. Upon later connections to the manager device 110, a playback device 105 does not need to be registered again. As described above, a registration process of a playback device 105 determines one or more optimized format parameter values of the playback device 105 that comprises the optimized playback format of the playback device 105. As shown in the example of FIG. 4B, data for each playback device 105 is stored in a playback device entry 510 produced for the playback device 105 in the media data structure 280.

FIG. 5 shows an exemplary media data structure 280. As shown in FIG. 5, the media data structure 280 comprises a plurality of playback device entries 550. Each playback device entry 550 represents a playback device 105 and stores data describing the playback device 105 in a plurality of data fields. For example, a playback device entry 550 may contain fields for a playback device identifier 555 and optimized format parameter values 515, e.g., encoding type, display aspect ratio, display resolution, etc.

As shown in the example of FIG. 5, a playback device entry 550 may also contain fields for compatibility data 520. For example, a playback device entry 550 may include fields for listing identifiers for zero or more “compatible” media files, zero or more “never-compatible” media files, and zero or more “incompatible” media files. A media file may be listed as compatible with a playback device when each specified format parameter value for the media file matches match each specified format parameter value for the playback device. A media file may be listed as “never-compatible” with a playback device when the media file can not be made compatible by any conversion of the media file such as when the transcoder 260 is not be capable of performing the required conversion.

In contrast, an “incompatible” media file may be incompatible with the playback device, but may be made compatible by conversion of one or more format parameters of the media file. For each incompatible media file, for a playback device entry 550 representing a playback device, the compatibility data 520 may further include differing format parameter values of the playback device that do not match the corresponding format parameter values of the incompatible media file. In some embodiments, the media data structure 280 may store compatibility data 520 for either the media files or the playback devices, but not store compatibility data for both media files and devices, since storing such compatibility data for both may be redundant.

In some embodiments, two playback formats are the same if they have the same values for each of their specified format parameters. For example, as shown in FIG. 5, MediaFile1 and PlaybackDevice2 may have a Format A that is specified by encoding type MPEG-4, display aspect ratio 16×9, and display resolution 1280×720. Also, MediaFile2 and PlaybackDevice1 may have a Format B that is specified by encoding type MPEG-4, display aspect ratio 16×9, and display resolution 720×480. Further, MediaFile3 and PlaybackDevice3 may have a Format C that is specified by encoding type Quicktime, display aspect ratio 4×3, and display resolution 720×480. As such, MediaFile1 and PlaybackDevice2 have the same Format A since they have the same values for each specified format parameter, whereas MediaFile2 and PlaybackDevice1 have a different Format B since they have a different specified value for the display resolution, and MediaFile3 and PlaybackDevice3 also have a different Format C since they have a different specified value for the encoding type, display aspect ratio, and display resolution.

As shown in FIG. 5, since MediaFile1 and PlaybackDevice2 have the same Format A and thus have the same values for each specified format parameter, MediaFile1 and PlaybackDevice2 are compatible, preferably optimized, and no conversion of any format parameters is needed for optimizing MediaFile1 for PlaybackDevice2. However, since MediaFile1 and PlaybackDevice1 have different formats, Format A and Format B, respectively, MediaFile1 and PlaybackDevice1 are not compatible, and are not optimized, as they have a differing value for the display resolution, 1280×720 and 720×480, respectively. As such, a conversion of MediaFile1 to an optimized display resolution of 720×480 for PlaybackDevice1 is needed for optimizing MediaFile1 for playback by using PlaybackDevice1.

As shown in FIG. 5, since MediaFile3 and PlaybackDevice3 have the same Format C and thus have the same values for each specified format parameter, MediaFile3 and PlaybackDevice3 are compatible, preferably optimized, and no conversion of any format parameters is needed for optimizing MediaFile3 for playback by using PlaybackDevice3. However, since MediaFile2 and PlaybackDevice3 have different formats, Format B and Format C, respectively, MediaFile2 and PlaybackDevice3 are not compatible, and not optimized, as they have a differing value for the encoding type (Quicktime) and display aspect ratio (4×3). As such, a conversion of MediaFile2 to an optimized encoding type (Quicktime) and display aspect ratio (4×3) for PlaybackDevice3 is needed for optimizing MediaFile2 for playback by using PlaybackDevice3.

For illustrative purposes only, the example of FIG. 5 may show single elements in various data fields. In other embodiments, multiple elements may be included for each data field. For example, for each media file entry 501, FIG. 5 shows one compatible playback device, one “never-compatible” playback device, and one “incompatible” playback device. In other embodiments, however, a media file entry 501 may list a plurality of “compatible” playback devices, “never-compatible” playback devices, or “incompatible” playback devices, and also list incompatible format parameter values for each listed incompatible playback device. For example, for each playback device entry 551, FIG. 5 may show one compatible media file, one never-compatible media file, and one incompatible media file. In other embodiments, a playback device entry 551 may list a plurality of compatible media files, never-compatible media files, or incompatible media files, and also list incompatible format parameter values for each listed incompatible media file.

Also, for illustrative purposes only, the example of FIG. 5 shows media file entries 501 that represent video media files. In other embodiments, a media file entry 501 may represent another type of media file, such as an audio, image, or gaming media file. Also, for illustrative purposes only, the example of FIG. 5 shows playback device entries 551 that represent video playback devices. In other embodiments, a playback device entry 551 may represent another type of playback device, such as an audio, image, or gaming playback device.

### D. Using the Media Data Structure to Convert Media Files

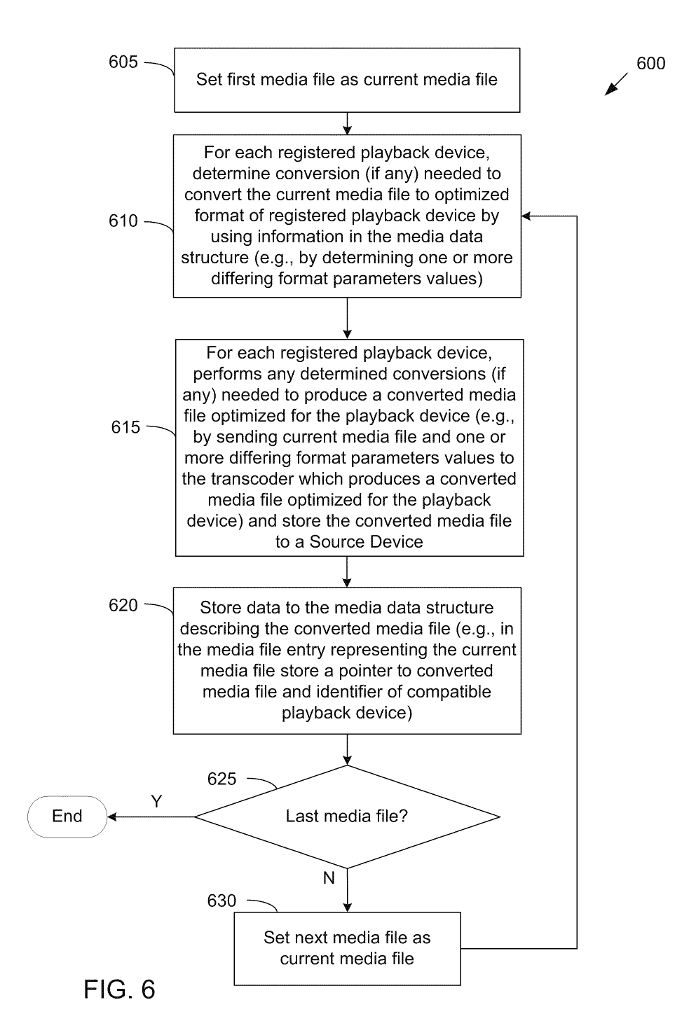

As described above, the compatibility data 520 stored in the media data structure may specify playback format conversions needed to make media files compatible with various playback devices. FIG. 6 is a flowchart of a method 600 for using the media data structure 280 for converting media files to the optimized formats of the registered playback devices. In some embodiments, some of the steps of the method 600 may be performed by the media manager UI 270 to perform a “pre-request conversion” of the media files. The media manager UI 270 may perform the method 600 to produce converted media files for original media files prior to receiving user requests for downloading the original media files onto playback devices, referred to as “pre-request conversion”.

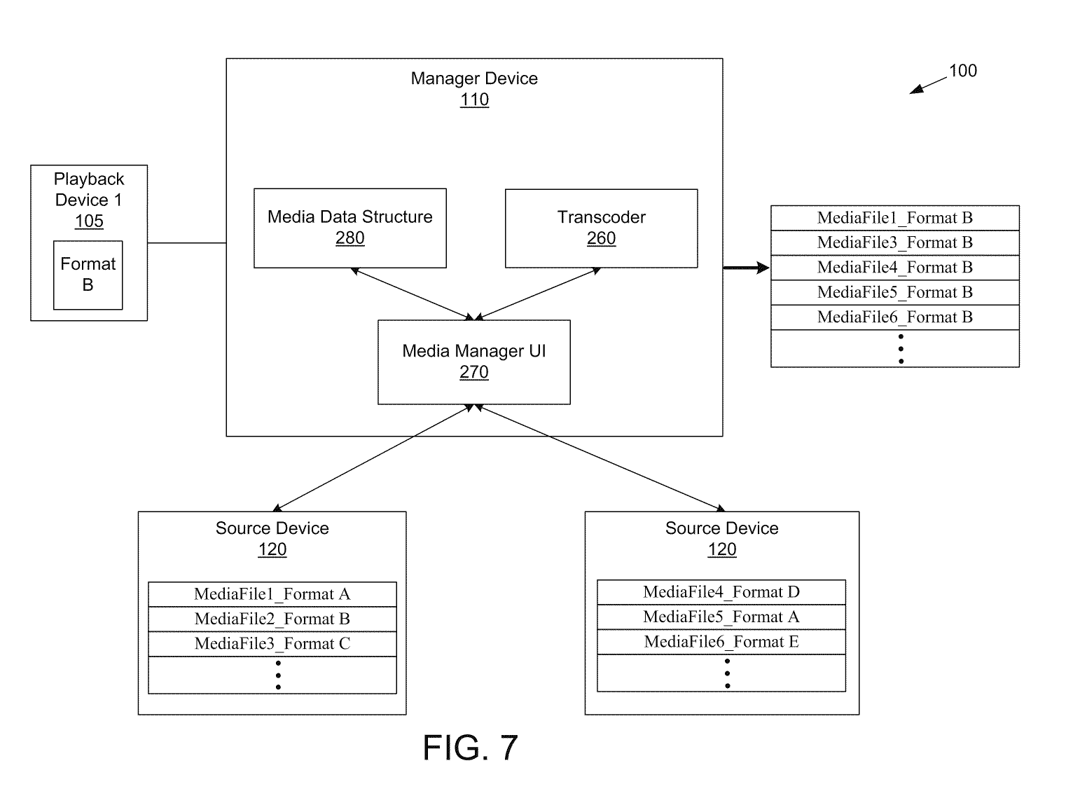

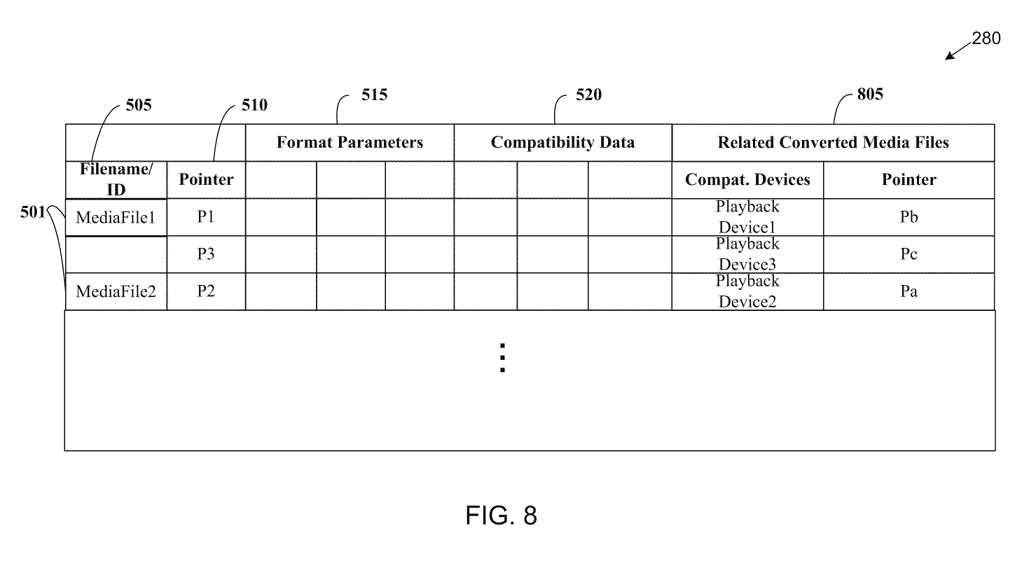

In some embodiments, some of the steps of the method 600 may be performed automatically, without requiring user and/or human initiation, interaction, or intervention. The order and number of steps of the method 600 are for illustrative purposes only and, in other embodiments, a different order and/or number of steps are used. The method 600 of FIG. 6 is described in relation to FIG. 7 which conceptually illustrates steps of the method 600, and FIG. 8 which shows an exemplary media data structure 280 containing data for converted media files.

As shown in FIG. 6, the method 600 begins by setting (at a step 605) a first media file in the media system 100 as a current media file for processing. The media file may be stored in a source device 120 of the media system 100. For each registered playback device in the media system 100, the method determines (at a step 610) a conversion, if any, needed to convert the current media file to the optimal format of the registered playback device. The method 600 may do so by using information in the media data structure 280. For example, the method 600 may examine the media file entry 501 representing the current media file and determine, for each registered playback device, if the current media file and the playback device are compatible. If so, no conversions are needed. If not, the method 600 may then determine one or more differing format parameter values of the current media file need to be converted to match the parameter values of the playback device to make the current media file compatible with the playback device.

For each registered playback device, the method 600 then performs (at a step 615) any determined conversions, if any, needed to produce a converted media file optimized for the playback device. The method may do so by sending the current media file and one or more differing format parameters values to the transcoder 260. The transcoder 260 then converts the current media file according to the received format parameters values to produce the converted media file optimized for the playback device. The method also stores (at a step 615) the converted media file to a source device 120.

The method 600 (at a step 620), then stores data to the media data structure 280 describing the converted media file. For example, the method 600 may store, in the media file entry 501 representing the current media file, a pointer to where the converted media file is stored and the identifier of the playback device that it is compatible with. The method 600 (at a step 625), then determines whether the current media file is the last media file in the media system 100. If so, the method ends. If not, the method 600 (at a step 630), sets a next media file in the media system 100 as a current media file for processing and returns to the step 610.

In some embodiments, for each media file, the method 600 (at the steps 610-615) automatically determines and performs conversions needed for media files for each registered playback device for example, by using the media data structure 280, stores (at the step 615) the converted media file to a source device 120, and stores data to the media data structure 280 describing the converted media file. The method may do without first requiring a user to request the media files to be examined.

To illustrate the steps of the method 600, FIG. 7 shows a media system 100 having various media files in different formats stored on source devices 120 and a registered PlaybackDevice1 having Format B. When processing MediaFile2, the media manager UI 270 may use the media data structure 280 to determine that MediaFile2 in Format B is compatible with PlaybackDevice1 and that no conversion is needed, as specified in the compatibility data 520 of the media data structure 280. When processing the other media files, however, the media manager UI 270 may use the media data structure 280 to determine that each media file is not compatible with and/or is not optimized for PlaybackDevice1 and determine one or more differing format parameter values for each media file, preferably, as specified in the compatibility data 520 of the media data structure 280. The media manager UI 270 may then convert an incompatible media file by sending the incompatible media file and one or more differing format parameters values to the transcoder 260. The transcoder 260 then converts the media file according to the received format parameters values to produce a converted media file in Format B that is optimized for PlaybackDevice1. FIG. 7 shows that converted media files in Format B have been produced for each incompatible media file. The converted media files may then be stored in any source device 120 of the media system 100.

The media manager UI 270 also stores data to the media data structure 280 describing the converted media file. FIG. 8 which shows an exemplary media data structure 280 containing data for converted media files. In these embodiments, for each media file entry 501 representing a particular media file, the media data structure 280 also contains fields for storing data 805 describing related converted media files of the particular media file. For example, for each related converted media file, a media file entry 501 may contain fields for an identifier of the playback device that the converted media file is compatible with, such as the playback device for which the converted media file was produced, and a pointer and/or a storage address to a storage location where the converted media file is stored for example, on the source device. The pointer to the converted media file may then be used to locate the converted media file for downloading onto the compatible playback device.

For example, when MediaFile1 is processed by the media manager UI 270, a converted media file “MediaFile1_FormatB” is produced for PlaybackDevice1, preferably in Format B, and stored to a storage location on a source device 120. As such, as shown in FIG. 8, the media manager UI 270 stores, in the media file entry 501 for MediaFile1, an identifier for the PlaybackDevice1, which is the playback device compatible with the converted media file MediaFile1_FormatB, and a pointer “Pb” to the storage location of the converted media file MediaFile1_FormatB. Upon receiving a user request for downloading the converted media file MediaFile1_FormatB onto the PlaybackDevice1, the pointer Pb may then be used to locate the converted media file MediaFile1_FormatB for downloading onto the PlaybackDevice1.

As another example, when MediaFile1 was processed by the media manager UI 270, a converted media file “MediaFile1_FormatC” was produced for a PlaybackDevice3, in Format C for this example, and stored to a storage location on a source device 120. As such, as shown in FIG. 8, the media manager UI 270 stores, in the media file entry 501 for the MediaFile3, an identifier for the PlaybackDevice3, which is the playback device compatible with converted media file MediaFile1_FormatC, and a pointer “Pc” to the storage of the converted media file MediaFile1_FormatC. Upon receiving a user request for downloading the converted media file MediaFile1_FormatC onto the PlaybackDevice3, the pointer Pc may then be used to locate the converted media file MediaFile1_FormatC for downloading onto the PlaybackDevice3.

In some embodiments, a source device 120 may store a plurality of “original” media files as well as “converted” media files that were produced by converting the playback format of “original” media files. The media manager UI 270 may perform the method 600 of FIG. 6 to produce, for each pairing of (1) an original media file and (2) a registered playback device, a converted media file that is compatible with the registered playback device. The media manager UI 270 may produce a converted media file for an original media file prior to receiving a user request for downloading the original media file onto a playback device. In some embodiments, this is referred to as “pre-request conversion”. For example, the media manager UI 270 may produce and store converted media files when resources of the manager device 110 are available such as in an off-line and/or batch mode. The advantage of pre-request conversion is that when a user submits a request for downloading an original media file onto a playback device, a converted media file that is compatible with the playback device is already produced and stored and ready for downloading. The disadvantage is that additional storage space is used for storing all the pre-request converted media files.

In other embodiments, the media manager UI 270 may produce a converted media file for an original media file after receiving a user request for downloading the original media file onto a playback device. In some embodiments, this is referred to as “post-request conversion”. The advantage of post-request conversion is that additional storage space is not used for storing all the converted media files. The disadvantage of post-request conversion is that there is a longer delay after a user submits a request for downloading an original media file onto a playback device for producing a converted media file that is compatible with the playback device. In some embodiments, the media manager UI 270 is user-configurable to perform either pre-request conversion or post-request conversion. Moreover, some embodiments may store the post-request converted files for faster response to repeated user requests for the same media file. Post-request conversion is discussed further in Section III.

### III. Media Manager UI

### A. Method of Media Manager UI for Managing Media Files and Playback Devices

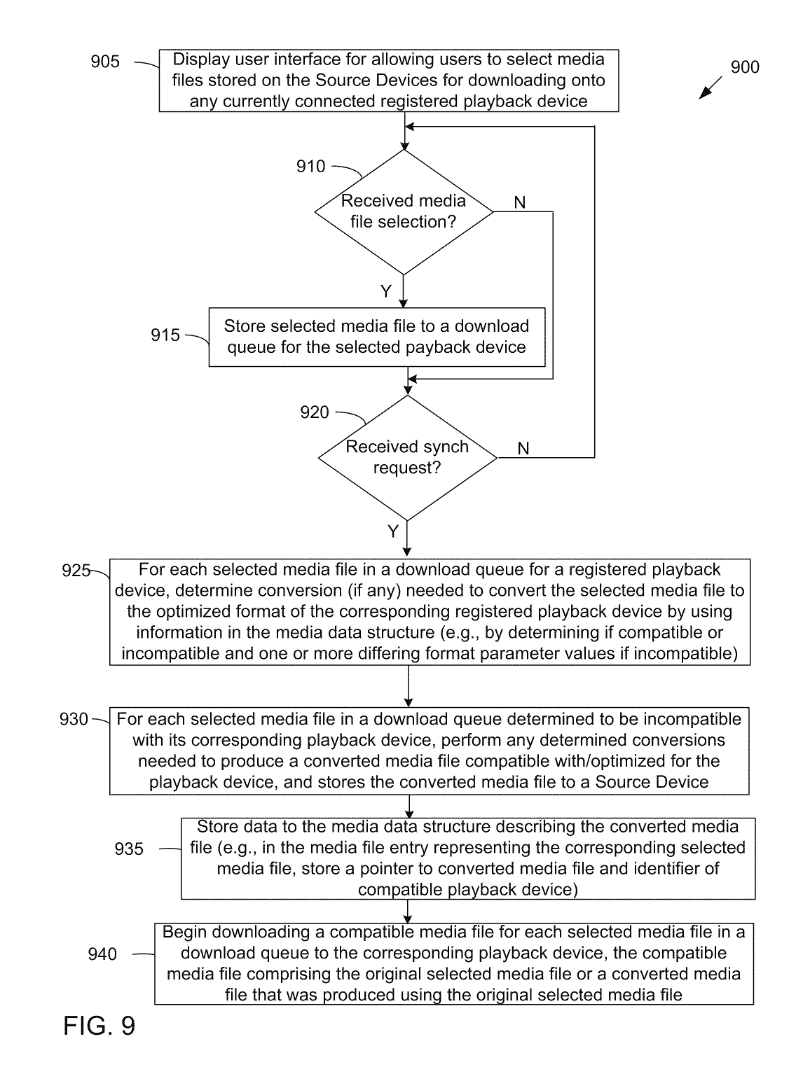

FIG. 9 is a flowchart of a method 900 for allowing users to select media files stored on the source devices 120 for downloading onto selected playback devices 105 and managing the various playback formats of the media files and playback devices. In some embodiments, some of the steps of the method 900 may be performed automatically, without requiring user and/or human initiation, interaction, or intervention. In some embodiments, some of the steps of the method 900 may be performed by the media manager UI 270. The order and number of steps of the method 900 are for illustrative purposes only and, in other embodiments, a different order and/or number of steps are used.

As shown in FIG. 9, the method 900 begins by displaying (at a step 905) a user interface for allowing users to select media files stored on the source devices 120 for downloading onto any registered playback device 105 that is currently coupled to the communication system 125 and the manager device 110. The method 900 may do so by displaying icons for the media files and each registered playback device including, preferably, the playback device(s) currently coupled to the communication system 125 and/or the manager device 110. The method 900 may also provide different media applications and user interfaces for different types of media files for example, audio, video, image files, and similar.

The method then determines (at a step 910) whether a user request for downloading a selected media file to a selected payback device has been received through the user interface. For example, in the user interface, a user drags and drops an icon for the selected media file to an icon for the selected payback device indicating a request for downloading the media file represented by the selected media file icon to the payback device represented by the selected playback device icon. If no request is received at the step 910, then the method 900 proceeds to a step 920. If a request is received at the step 910, then the method stores (at a step 915) the selected media file to a download queue for the selected payback device and display (in the UI) an icon representing the selected media file in the download queue.

At the step 920, the method 900 determines whether a user “synch” request for synchronizing the downloading requests has been received. More specifically, the user synch request is a request for beginning the download of media files in each download queue for each payback device. For example, in the user interface, a “begin-download” (e.g., “Synch”) icon may be displayed and the user clicks on the “begin-download” icon to request beginning the download of media files in each download queue for each payback device. If not, the method 900 returns to the step 910. If so, the method 900 proceeds to the step 925.

In some embodiments, the steps 925-935 are optional, depending on whether the media manager UI is implementing pre-request or post-request conversion. If the media manager UI is implementing pre-request conversion, a compatible converted media file for each selected media file for a registered playback device has already been produced such as by using the method 600 of FIG. 6, for example. As such, the steps 925-935 may be omitted. If the media manager UI is implementing post-request conversion, then the steps 925-935 may be performed to produce a compatible converted media file for each selected media file stored in the download queue for each registered playback device.

At the step 925, for each selected media file stored in a download queue for a registered playback device, the method 900 determines whether the selected media file and the selected playback device are compatible and whether a conversion, if any, is needed to convert the selected media file to an optimized format of the corresponding registered playback device for which the selected media file is queued. The method 900 may do so by using information in the media data structure 280. For example, the method 900 may examine the media file entry 501 representing a selected media file and determine if the selected media file and the corresponding registered playback device, e.g., for which the selected media file is queued, are compatible. If so, no conversions are needed. If not, the method 900 may then determine that the selected media file is incompatible and determine one or more differing format parameter values of the playback device to which the corresponding format parameter(s) of the selected media file needs to be converted.

For each selected media file in a download queue determined to be incompatible with its corresponding playback device, the method 900 then performs (at the step 930) any determined conversions needed to produce a converted media file compatible with and/or optimized for the playback device. The method may do so by sending each incompatible selected media file and its corresponding one or more differing format parameters values to the transcoder 290. The transcoder 290 then converts the incompatible selected media file according to the received format parameter values to produce the converted media file optimized for the corresponding playback device. The method also stores (at the step 930) the converted media file to a source device 120. The method 900 then stores (at the step 935) data to the media data structure 280 describing each converted media file. For example, in the media file entry 501 representing the corresponding selected media file, which is the media file used to produce the converted media file, the method 900 may store a pointer to where the converted media file is stored and the identifier of the playback device with which the converted media file is compatible.

The method 900 then begins downloading (at the step 940) a compatible media file for each selected media file stored in the download queue of each playback device. The compatible media file may comprise the original selected media file or a converted media file that was produced by using the original selected media file. If the compatible media file comprises the original selected media file, the method 900 may retrieve and download the original selected media file by using the pointer for the original selected media file. The pointer for the original media file is preferably stored in the entry 501 for the original selected media file in the media data structure. If the compatible media file comprises a converted media file that was produced by using the original selected media file, the method 900 may retrieve and download the converted media file by using the pointer for the converted media file. The point for the converted media file is preferably stored in the “related media file” data 805 section of the entry 501 for the original selected media file in the media data structure. The method 900 then concludes, after the step 940.

### B. Screen Shots of the Media Manager UI

In some embodiments, the manager device 110 provides a media manager UI 270 for allowing users to select media files that are generally stored on source devices, for downloading, streaming, and/or delivering the media files onto currently coupled playback devices, and for managing the various playback formats of the media files and playback devices. A user may access and control the functions of the manager device 110 through the media manager UI 270. In one embodiment, the media manager UI 270 produces a plurality of user interactive screens shown on a display coupled with the manager device 110. A screen of the media manager UI 270 may include one or more items for selection by a user. The user navigates through the screen and makes item selections by using a user input device for example, a mouse, trackball, keypad, touchscreen, etc. As a further example, the display showing the UI screens may comprise a television, whereby the user may navigate through the screen and makes item selections by using a remote control device.

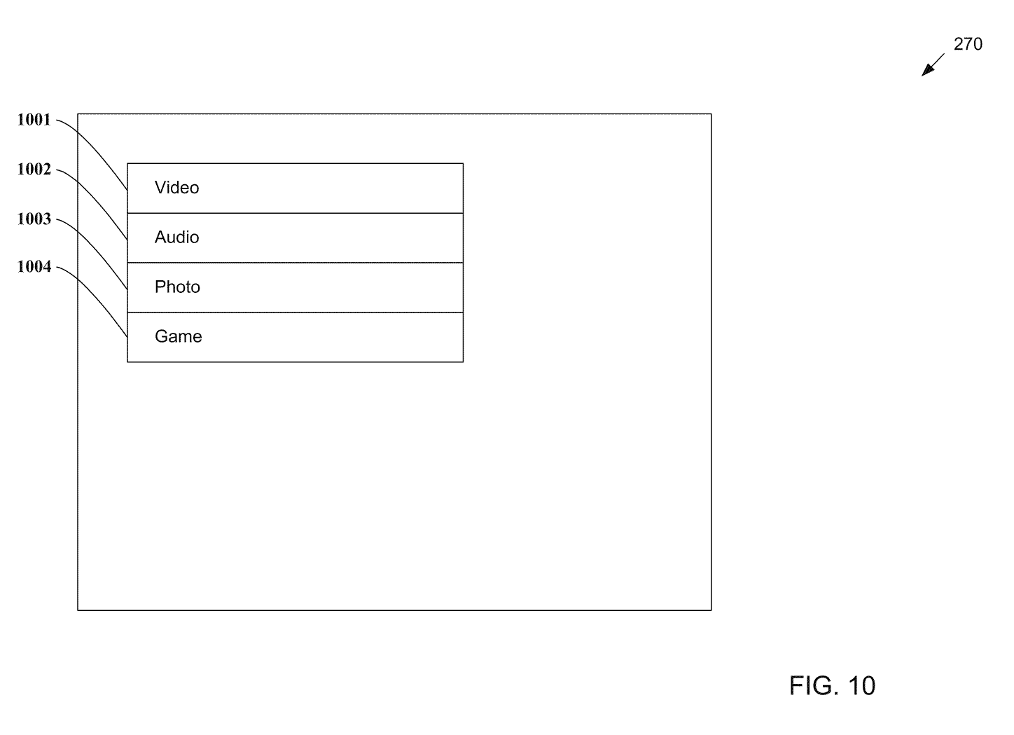

FIGS. 10, 11, 12, 13, 14, 15, and 16 show exemplary screen shots of the media manager UI 270 used in some embodiments. The media manager UI 270 may comprise different media user interface (UI) applications for different types of media files including, for example, audio, video, and/or image files, and the like. FIG. 10 shows an exemplary screen shot of a menu interface 270 for allowing a user to select a video UI application 1001, an audio UI application 1002, an image and/or photo UI application 1003, or a video game UI application 1004. For example, a user may select the video UI application 1001. Although the video UI application 1001 is described in embodiments below, the embodiments may also apply to any other UI application including, for example, audio, image and/or photo, or video game UI applications.

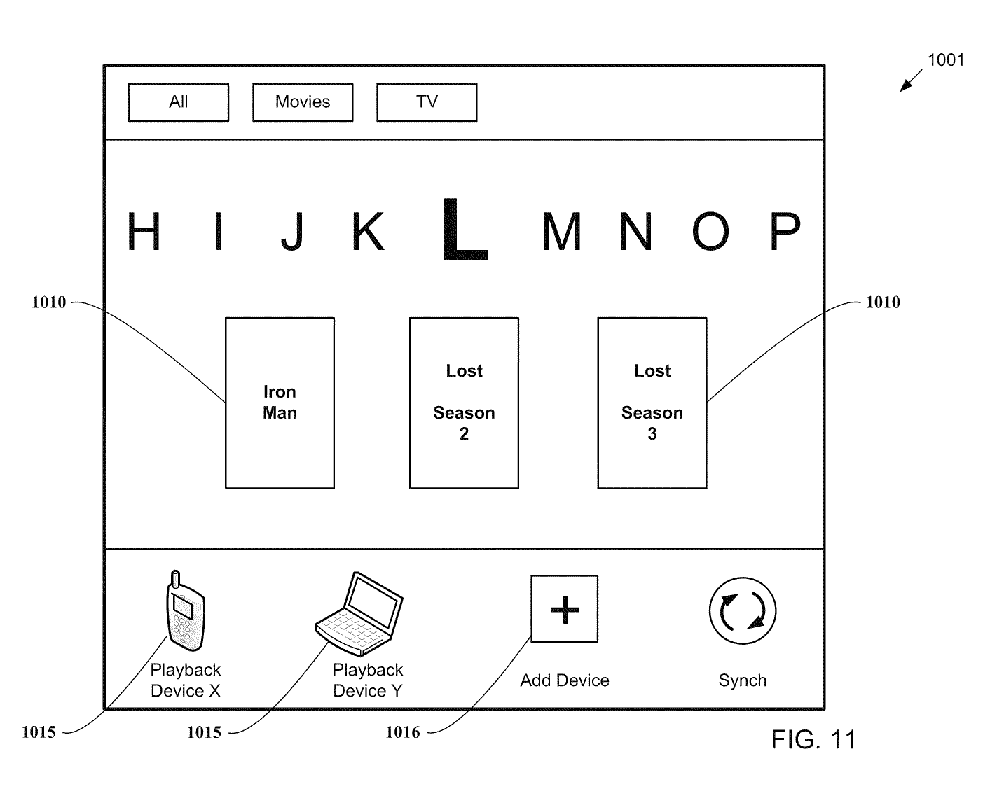

FIG. 11 shows an exemplary screen shot of a video UI application 1001 presenting/displaying information, such as selectable media file icons 1010, for representing video media items. As used herein, an icon may comprise text, graphics, an image, or any combination of these. A media item may represent a single video media file or a set of two or more video media files, such as a set of episodes for an entire season of a television program, that are stored on a source device 120 in the media system 100. For example, the video UI 1001 may display the media file icons 1010 for the media items in alphabetical order and/or display the media file icons 1010 based on type for example, movie, television, or all.

Also, for each registered playback device that is currently coupled to the manager device 110, the video UI application 1001 may display/present a selectable playback device icon 1015, e.g., “PlaybackDeviceX” or “PlaybackDeviceY,” representing the playback device. The video UI application 1001 may also display a selectable “Add Device” icon 1016, that when selected, allows a user to manually begin the registration process for a new playback device that is currently coupled. Registration of playback devices is discussed above in relation to FIG. 3B.

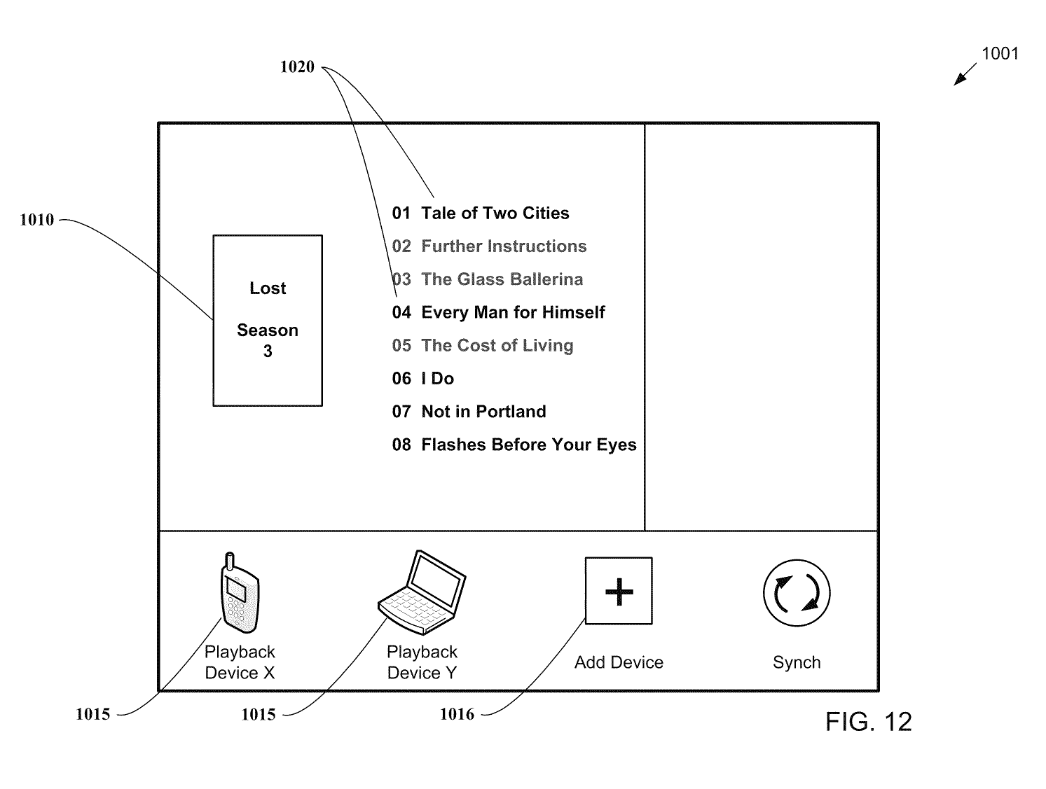

FIG. 12 shows an exemplary screen shot of a video UI application 1001 displaying information, e.g., text and/or graphics, such as icons, for representing video media files. In the example of FIG. 12, the media file icon 1010 for media item “Lost Season 3” is selected by the user, the media item comprising a set of video media files 1020, each media file 1020 being represented in the UI by additional media file icons comprising, for example, text. In some embodiments, the video UI 1001 may further display information indicating whether or not a media file is stored and available on a source device 120 in the media system 100. In the example of FIG. 12, text representing a media file 1020 that is not stored and available on a source device 120 in the media system 100 is dimmed, whereas text representing a media file 1020 that is stored on a source device 120 in the media system 100 is not dimmed.

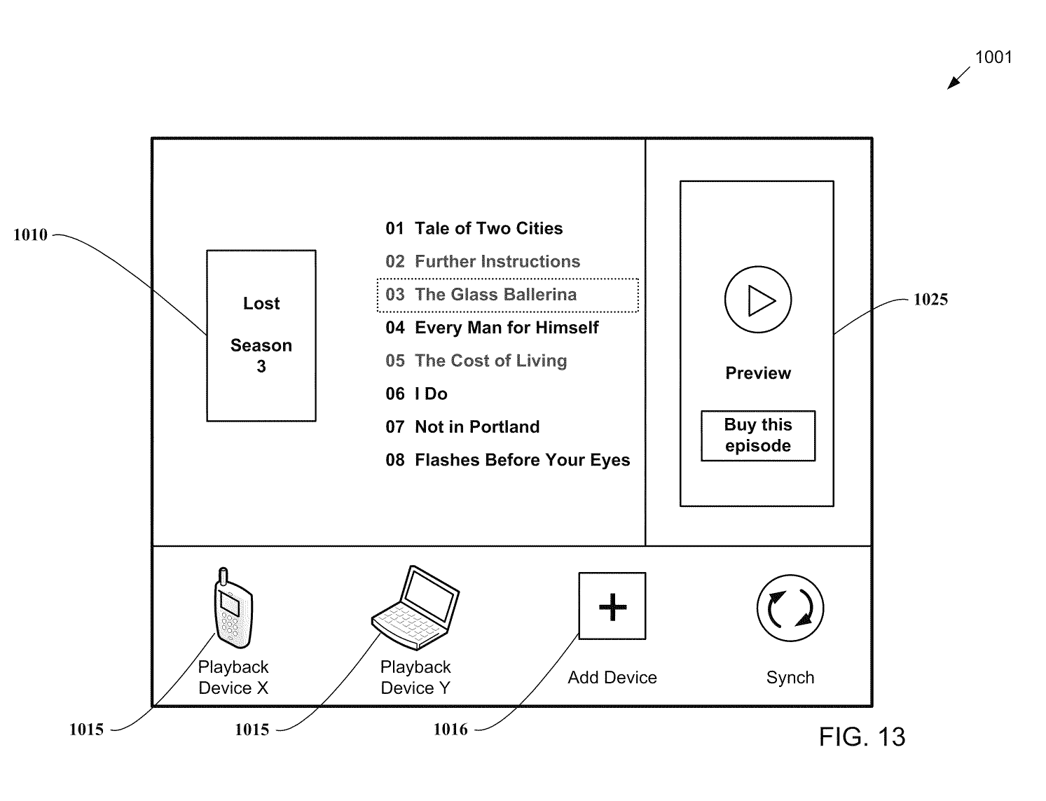

FIG. 13 shows an exemplary screen shot of a video UI application 1001 for purchasing and downloading media files from a content provider 140 located external to the home and/or local media system 100. In the example of FIG. 13, the user has selected text, as indicated by the dashed box. The selected text represents a media file that is not stored and available in the media system 100. Accordingly, the selected media file is represented by the highlighted text “03 The Glass Ballerina”. In response, the video UI application 1001 displays a purchasing interface 1025 for purchasing and downloading the selected media file from a content provider 140. The purchasing interface 1025 may include a “preview” icon for previewing the selected media file and a “purchase” icon for purchasing and downloading the selected media file.

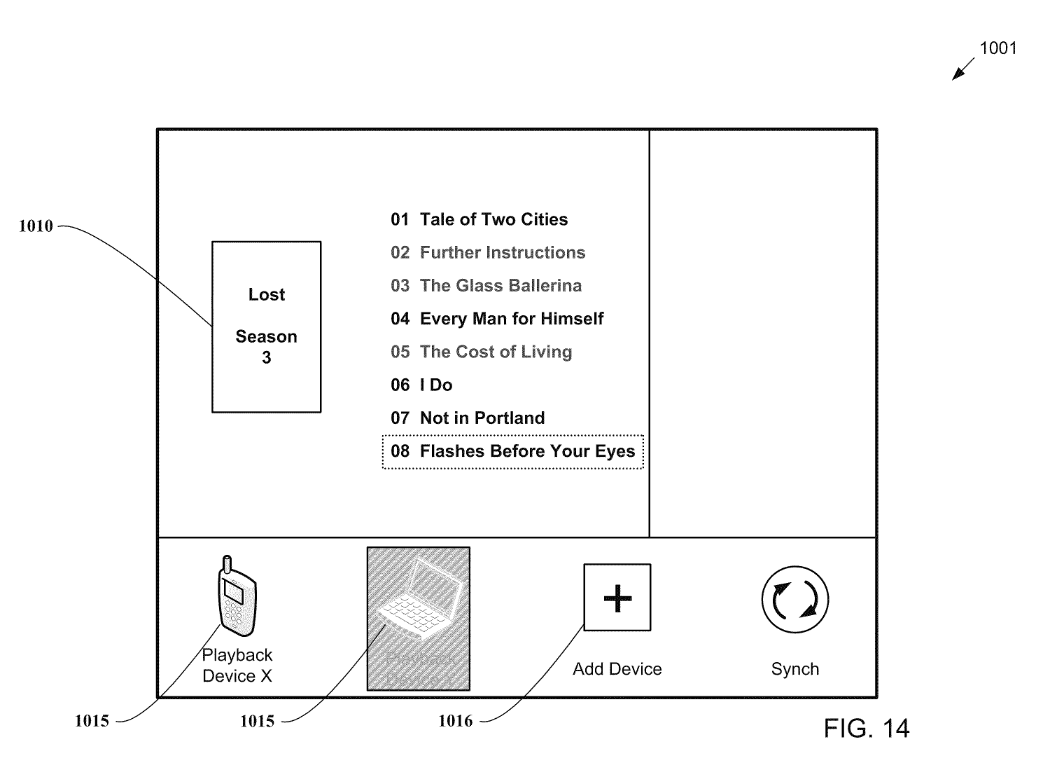

FIG. 14 shows an exemplary screen shot of a video UI application 1001 displaying “never compatible” playback devices. In the example of FIG. 14, the user has selected text, as indicated by the dashed box. The selected text represents a media file that is stored and available in the media system 100. Accordingly, the selected media file is represented by the highlighted text “08 Flashes Before Your Eyes”. In some embodiments, upon the user selecting, e.g., clicking on, the text representing an available media file, the video UI application 1001 displays information, e.g., text and/or graphics, indicating whether a playback device is compatible, incompatible, or never compatible with the currently selected and/or clicked-on media file. As discussed above, an “incompatible” playback device may be made “compatible” by conversion of the selected media file, whereas a “never-compatible” playback device may not be made compatible by any conversion of the selected media file, dependent on the conversion capabilities of the transcoder 260.

As shown in the example of FIG. 14, the video UI application 1001 may display a shaded and/or dimmed playback device icon 1015 for a never compatible playback device for example, PlaybackDeviceY, and a non-shaded and/or non-dimmed icon for a compatible or incompatible playback device, for example, PlaybackDeviceX. The video UI application 1001 may determine which playback device is “never-compatible” by examining the compatibility data 520 in the media data structure. For example, the video UI application 1001 may examine the media file entry 501 for the selected media file and determine if the playback device is a “never-compatible” playback device and display information in the user interface accordingly. As such, the video UI application 1001 may display a modified icon for the “never-compatible” playback device that indicates the playback device is never compatible with the selected media file.

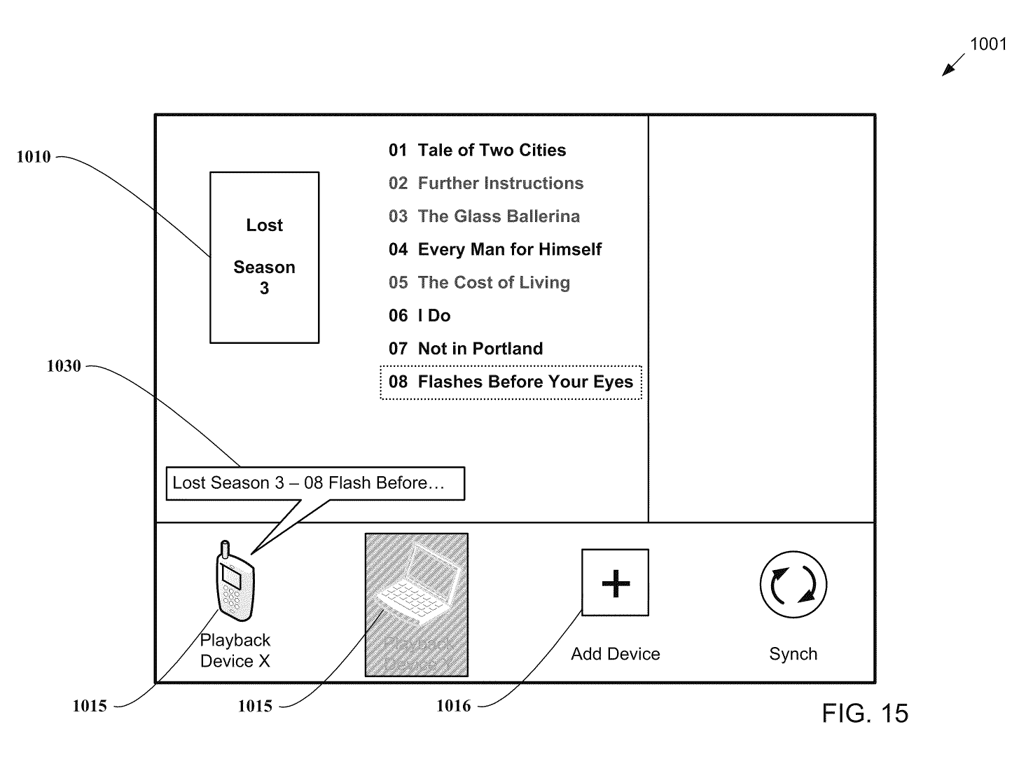

FIG. 15 shows an exemplary screen shot of a video UI application 1001 displaying a download queue 1030 for a playback device. In the example of FIG. 15, the user has selected a media file icon 1010 representing, for example, the media file “08 Flashes Before Your Eyes,” for download to a selected playback device icon 1015 representing, for example, PlaybackDeviceX. For example, the user may do so by dragging and dropping the media file icon 1010 representing the media file onto the playback device icon 1015 representing the playback device to indicate the selection. In response to the selection, the video UI application 1001 may display a download queue 1030 for the selected playback device and display a media file icon 1010 representing the selected media file in the download queue 1030.

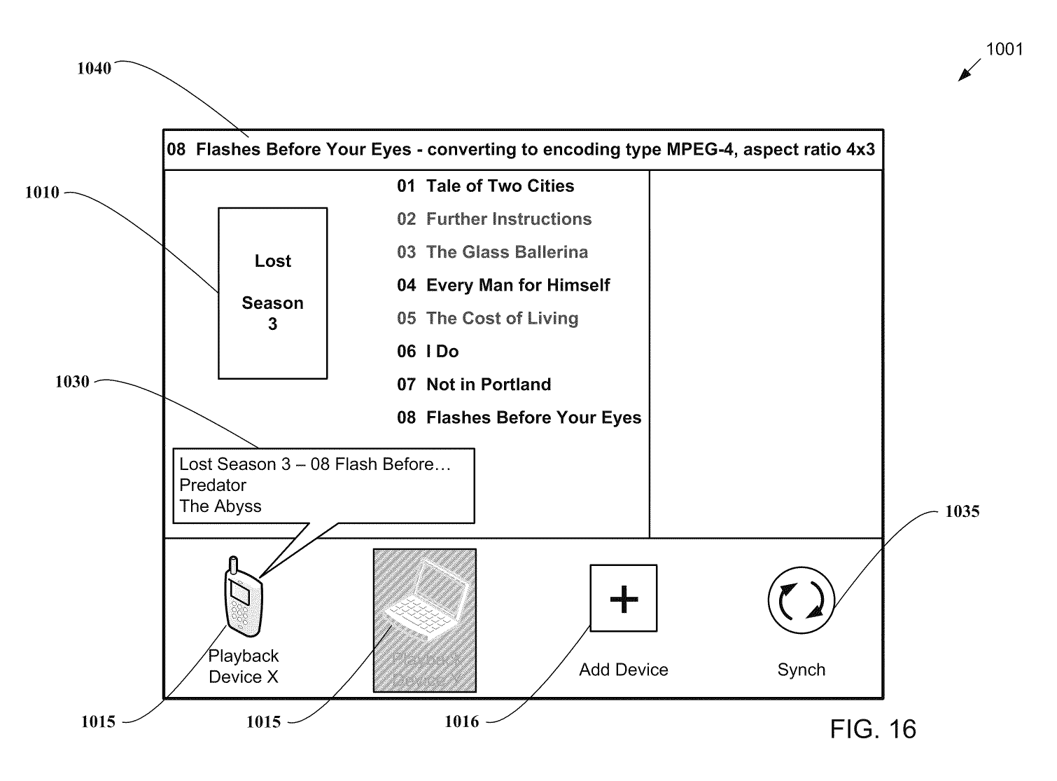

FIG. 16 shows an exemplary screen shot of a video UI application 1001 displaying a selectable “Synch” icon 1035 for beginning download of selected media files. In the example of FIG. 16, the user has selected various media file icons representing various media files, for example, the media file “08 Flashes Before Your Eyes,” etc., for download to a selected playback device for example, PlaybackDeviceX. All the selected media files are stored in the download queue 1030 for the selected playback device. Upon the user selecting and/or clicking the “Synch” icon, in response the video UI application 1001 may begin the download of media files stored in a download queue 1030 (and represented by media file icons in the download queue 1030) to the corresponding playback device.

Download of selected media files to playback devices is discussed above in relation to FIG. 9. As discussed, media files may be converted by using pre-request conversion or post-request conversion methods. If pre-request conversion is used, a converted media file, that is compatible with the selected playback device, may have already been produced for each queued media file. As such, when using pre-request conversion, the video UI application 1001 may simply retrieve a compatible media file for each queued media file, whereby the compatible media file may comprise the original media file or a converted media file.

If post-request conversion is used, prior to downloading the media files to the selected playback device, the video UI application 1001 may need to produce a converted media file that is compatible with the selected playback device for one or more of the queued media files. In these embodiments, the video UI application 1001 may also display a status bar 1040 for displaying conversion information regarding the conversion currently being performed. For example, the status bar 1040 may display the identifier of the media file currently being converted and one or more differing format parameter values that are being converted to the appropriate format parameter values of the selected playback device. For instance, when the media file comprises “08 Flashes Before Your Eyes,” converting the media file includes converting the encoding type of the media file to MPEG-4, and/or converting the aspect ratio of the media file to “4×3”. The video UI application 1001 may determine the differing format parameter values to be displayed by examining the compatibility data 520 in the media data structure. For example, the video UI application 1001 may examine the media file entry 501 for the media file currently being converted and determine the differing format parameter values with the selected playback device.

Although the video UI application 1001 is described in embodiments above, the embodiments may also apply to another UI application for example, audio, image, photo, and/or or game UI applications. In these embodiments, features shown in FIGS. 11, 12, 13, 14, 15 and 16, may also be used in each of the other UI applications. For example, the exemplary screen shot of FIG. 11 may be adapted to alternatively show a UI application displaying audio, image, and/or game media items. The exemplary screen shot of FIG. 12 may be adapted to display audio, image, or game media files. The exemplary screen shot of FIG. 13 may be adapted for purchasing and/or obtaining audio, image, and/or game media files from a content provider; the exemplary screen shot of FIG. 14 may be adapted to display playback devices that are “never-compatible” with audio, image, or game media files. The exemplary screen shot of FIG. 15 may be adapted to display a download queue comprising audio, image, or game media files for a playback device. The exemplary screen shot of FIG. 16 may be adapted to display a “Synch” icon for beginning download of selected audio, image, or game media files.

### C. Various Embodiments

Some embodiments may be conveniently implemented by using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented by using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer readable medium and/or media having instructions stored thereon or therein and, when executed for example, by a processor, the instructions perform methods, techniques, or embodiments described herein, the computer readable medium comprising sets of instructions for performing various steps of the methods, techniques, or embodiments described herein. The computer readable medium may comprise a storage medium having instructions stored thereon or therein, which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices including flash cards, magnetic or optical cards, nanosystems including molecular memory ICs, RAID devices, remote data storage/archive/warehousing, or any other type of media or device suitable for storing instructions and/or data thereon or therein.

Stored on any one of the computer readable medium and/or media, some embodiments include software instructions for controlling both the hardware of the general purpose or specialized computer or microprocessor, and for enabling the computer or microprocessor to interact with a human user and/or other mechanism by using the results of an embodiment. Such software may include without limitation device drivers, operating systems, and user applications. Ultimately, such computer readable media further includes software instructions for performing embodiments described herein. Included in the programming and/or software of the general-purpose and/or specialized computer or microprocessor are software modules for implementing some embodiments.

Those of skill would further appreciate that the various illustrative logical blocks, modules, circuits, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software application, module, or layer described herein may comprise an engine comprising firmware or software and hardware configured to perform embodiments described herein. In general, functions of a software application, module, or layer described herein may be embodied directly in hardware, or embodied as software executed by a processor, or embodied as a combination of the two. A software application, module, or layer may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

What is claimed is:

1. A computer readable medium having instructions stored thereon when executed by a processor, provide a media manager user interface (UI) for managing playback formats of a media system comprising at least one playback device and at least one source device configured for storing a plurality of media files, the computer readable medium comprising sets of instructions for:
displaying media file icons for representing the plurality of media files, each media file having a format defined by at least one format parameter value;
displaying at least one playback device icon for representing the at least one playback device, the at least one playback device configured for playing media files in a format defined by at least one format parameter value;
receiving a selection of a media file icon representing a selected media file and a playback device icon representing a selected playback device;
determining whether the selected media file is compatible with the selected playback device by using a media data structure comprising compatibility data indicating compatibility between the plurality of media files and the at least one playback device.

2. The computer readable medium of claim 1, wherein the selection of the media file icon and the selection of the playback device icon indicates a user request for downloading the selected media file to the selected payback device, the computer readable medium further comprising sets of instructions for:
displaying a download queue for the selected playback device; and
displaying the selected media file icon in the download queue.

3. The computer readable medium of claim 2, further comprising sets of instructions for:
displaying a selectable begin-download icon;
receiving a selection of the begin-download icon; and
beginning downloading of media files in each download queue for each payback device.

4. The computer readable medium of claim 1, further comprising sets of instructions for:
displaying an add device icon;
receiving a selection of the add device icon; and
begin registration of a new playback device for determining at least one format parameter value of the playback device that is stored to the media data structure.

5. The computer readable medium of claim 1, further comprising sets of instructions for:
determining, using the media data structure, that the selected media file is never compatible with a format of a particular playback device; and
displaying a modified icon for the particular playback device that indicates the playback device is never compatible with the selected media file.

6. The computer readable medium of claim 1, wherein the media data structure comprises a plurality of media file entries for the plurality of media files, each media file entry representing a media file, wherein for each media file in the plurality of media files, the computer readable medium further comprises sets of instructions for:
determining compatibility data indicating compatibility of the format of the media file with the format of each playback device, and storing the compatibility data to the media file entry for the media file in the media data structure; and
for at least one media file, using the compatibility data in the media file entry for the media file to convert the media file to a format of at least one playback device.

7. The computer readable medium of claim 1, wherein the media data structure comprises at least one playback device entry representing at least one playback device, wherein for each playback device, the computer readable medium further comprises sets of instructions for:
determining compatibility data indicating compatibility of the format of the playback device with the format of each media file in the plurality of media files, and storing the compatibility data to the playback device entry for the playback device in the media data structure; and
for at least one media file, using the compatibility data in a playback device entry for a playback device to convert the media file to a format of the playback device.

8. The computer readable medium of claim 1, wherein:
a format parameter comprises an encoding type, display aspect ratio, or display resolution; and
the plurality of media files comprises video, audio, image, or gaming media files.

9. The computer readable medium of claim 1, wherein a format of a playback device comprises zero or more required format parameter values and zero or more preferred format parameter values.

10. The computer readable medium of claim 1, wherein compatibility data for a media file indicates:
the format of the media file is compatible with a format of a playback device;
the format of the media file is incompatible with a format of a playback device and can be converted by a transcoder to the format of the playback device; or
the format of the media file is incompatible with a format of a playback device and can not be converted by the transcoder to the format of the playback device.

11. The computer readable medium of claim 1, wherein the media manager UI is configured for producing the media data structure, determining compatibility data for each media file and store the compatibility data to the media data structure, and use the compatibility data stored in the media data structure to convert the format of a media file automatically, without requiring user initiation, interaction, or intervention.

12. A media system for managing playback formats of media files, the media system comprising:
at least one source device configured for storing a plurality of media files, each media file having a format defined by at least one format parameter value;
at least one playback device configured for playing media files in a format defined by at least one format parameter value;
a media manager user interface (UI) engine coupled with the at least one source device and the at least one playback device, the media manager UI engine configured for:
displaying media file icons for representing the plurality of media files;
displaying at least one playback device icon for representing the at least one playback device;
receiving a selection of a media file icon representing a selected media file and a playback device icon representing a selected playback device;
determining whether the selected media file is compatible with the selected playback device by using a media data structure comprising compatibility data indicating compatibility between the plurality of media files and the at least one playback device.

13. The media system of claim 12, wherein the selection of the media file icon and the selection of the playback device icon indicates a user request for downloading the selected media file to the selected payback device, the media manager UI engine further configured for:
displaying a download queue for the selected playback device; and
displaying the selected media file icon in the download queue.

14. The media system of claim 13, the media manager UI engine further configured for:
displaying a selectable begin-download icon;
receiving a selection of the begin-download icon; and
beginning downloading of media files in each download queue for each payback device.

15. The media system of claim 12, the media manager UI engine further configured for:
displaying an add device icon;
receiving a selection of the add device icon; and
begin registration of a new playback device for determining at least one format parameter value of the playback device that is stored to the media data structure.

16. The media system of claim 12, the media manager UI engine further configured for:
determining, using the media data structure, that the selected media file is never compatible with a format of a particular playback device; and
displaying a modified icon for the particular playback device that indicates the playback device is never compatible with the selected media file.

17. The media system of claim 12, wherein the media data structure comprises a plurality of media file entries for the plurality of media files, each media file entry representing a media file, wherein for each media file in the plurality of media files, the media manager UI engine further configured for:
determining compatibility data indicating compatibility of the format of the media file with the format of each playback device, and storing the compatibility data to the media file entry for the media file in the media data structure; and
for at least one media file, using the compatibility data in the media file entry for the media file to convert the media file to a format of at least one playback device.

18. The media system of claim 12, wherein the media data structure comprises at least one playback device entry representing at least one playback device, wherein for each playback device, the media manager UI engine is further configured for:
determining compatibility data indicating compatibility of the format of the playback device with the format of each media file in the plurality of media files, and storing the compatibility data to the playback device entry for the playback device in the media data structure; and
for at least one media file, using the compatibility data in a playback device entry for a playback device to convert the media file to a format of the playback device.

19. The media system of claim 12, wherein:
a format parameter comprises an encoding type, display aspect ratio, or display resolution; and
the plurality of media files comprises video, audio, image, or gaming media files.

20. The media system of claim 12, wherein a format of a playback device comprises zero or more required format parameter values and zero or more preferred format parameter values.

21. The media system of claim 12, wherein compatibility data for a media file indicates:
the format of the media file is compatible with a format of a playback device;
the format of the media file is incompatible with a format of a playback device and can be converted by a transcoder to the format of the playback device; or
the format of the media file is incompatible with a format of a playback device and can not be converted by the transcoder to the format of the playback device.

22. The media system of claim 12, wherein the media manager UI is further configured for producing the media data structure, determining compatibility data for each media file and store the compatibility data to the media data structure, and use the compatibility data stored in the media data structure to convert the format of a media file automatically, without requiring user initiation, interaction, or intervention.
